(19) United States
(12) Patent Application Publication
(10) Pub. No.: US 2025/0287306 A1
(43) Pub. Date: Sep. 11, 2025

(54) ACCESS POINT TRANSMISSION SERVICE PERIOD COORDINATION

(71) Applicant: QUALCOMM Incorporated, San Diego, CA (US)

(72) Inventors: Giovanni CHISCI, San Diego, CA (US); Abhishek Pramod PATIL, San Diego, CA (US); Sai Yiu Duncan HO, San Diego, CA (US); George CHERIAN, San Diego, CA (US); Gaurang NAIK, San Diego, CA (US); Alfred ASTERJADHI, San Diego, CA (US); Sherief HELWA, San Diego, CA (US); Sanket Sanjay KALAMKAR, San Diego, CA (US)

(21) Appl. No.: 19/070,213

(22) Filed: Mar. 4, 2025

Related U.S. Application Data
(60) Provisional application No. 63/561,691, filed on Mar. 5, 2024.
(60) Provisional application No. 63/717,084, filed on Nov. 6, 2024.

(51) Int. Cl. H04W 52/02

(52) U.S. Cl. CPC H04W 52/0216

(57) ABSTRACT

This disclosure provides methods, components, devices and systems for access point (AP) transmission service period coordination. Some aspects more specifically relate to coordination between AP and stations (STAs) for latency-sensitive data transmissions. As part of coordination procedures, a first wireless device (such as a first AP) may transmit one or more first messages to one or more second wireless devices (other APs or STAs) to request that the one or more second wireless devices refrain from transmitting communications at the start of the one or more service periods, during the one or more service periods, or both. The one or more first messages also may indicate one or more channel access parameters for the one or more second wireless devices to apply during the one or more service periods. Therefore, the AP transmission service period coordination may enable enhanced communications between wireless devices during the one or more service periods.

### CROSS REFERENCE

This patent application claims the benefit of U.S. Provisional Patent Application No. 63/717,084 by CHISCI et al., entitled “ACCESS POINT TRANSMISSION SERVICE PERIOD COORDINATION,” filed Nov. 6, 2024, and claims the benefit of U.S. Provisional Patent Application No. 63/561,691 by CHISCI et al., entitled “ACCESS POINT TRANSMISSION SERVICE PERIOD COORDINATION,” filed Mar. 5, 2024, each of which is assigned to the assignee hereof, and expressly incorporated herein.

### TECHNICAL FIELD

This disclosure relates generally to wireless communication and, more specifically, to access point (AP) transmission service period coordination for communications between APs and stations (STAs) associated with the APs.

### DESCRIPTION OF THE RELATED TECHNOLOGY

Wireless communication networks are widely deployed to provide various types of communication content such as voice, video, packet data, messaging, broadcast, and so on. Some wireless communication networks may be capable of supporting communication with multiple users by sharing the available system resources (such as time, frequency, or power). Further, a wireless communication network may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM), among other examples. Wireless communication devices may communicate in accordance with any one or more of such wireless communication technologies, and may include wireless stations (STAs), wireless access points (APs), user equipment (UEs), network entities, or other wireless nodes.

In some WLANs, APs manage traffic associated with relatively high reliability and low latency, such as traffic associated with voice over internet protocol (VoIP), video streaming, online and cloud-based gaming, extended reality (XR) traffic, and other applications or protocols that rely on near-real time operations. APs may prioritize data packets that have stringent latency expectations to ensure seamless stable latency-sensitive communications.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications is described. The method may include transmitting, from a first access point (AP) to a second AP, a first individually addressed management frame, the first individually addressed management frame including an indication of at least one requested coordination scheme between the first AP and the second AP, the at least one requested coordination scheme associated with one or more coordinated restricted target wake time schedules, and the first individually addressed management frame further including an element that indicates a respective requested parameter set associated with each coordinated restricted target wake time schedule of the one or more coordinated restricted target wake time schedules, receiving, from the second AP, a second individually addressed management frame including an indication of an acceptance of at least one coordinated restricted target wake time schedule of the one or more coordinated restricted target wake time schedules, and communicating one or more messages during one or more service periods of the at least one coordinated restricted target wake time schedule.

Another innovative aspect of the subject matter described in this disclosure can be implemented in an apparatus for wireless communications for wireless communications is described may include a processing system that includes processor circuitry and memory circuitry that stores code. The processing system may be configured to cause the apparatus to transmit, from a first AP to a second AP, a first individually addressed management frame, the first individually addressed management frame including an indication of at least one requested coordination scheme between the first AP and the second AP, the at least one requested coordination scheme associated with one or more coordinated restricted target wake time schedules, and the first individually addressed management frame further including an element that indicates a respective requested parameter set associated with each coordinated restricted target wake time schedule of the one or more coordinated restricted target wake time schedules, receive, from the second AP, a second individually addressed management frame including an indication of an acceptance of at least one coordinated restricted target wake time schedule of the one or more coordinated restricted target wake time schedules, and communicate one or more messages during one or more service periods of the at least one coordinated restricted target wake time schedule.

Another innovative aspect of the subject matter described in this disclosure can be implemented in an apparatus for wireless communications which may include means for transmitting, from a first AP to a second AP, a first individually addressed management frame, the first individually addressed management frame including an indication of at least one requested coordination scheme between the first AP and the second AP, the at least one requested coordination scheme associated with one or more coordinated restricted target wake time schedules, and the first individually addressed management frame further including an element that indicates a respective requested parameter set associated with each coordinated restricted target wake time schedule of the one or more coordinated restricted target wake time schedules, means for receiving, from the second AP, a second individually addressed management frame including an indication of an acceptance of at least one coordinated restricted target wake time schedule of the one or more coordinated restricted target wake time schedules, and means for communicating one or more messages during one or more service periods of the at least one coordinated restricted target wake time schedule.

Another innovative aspect of the subject matter described in this disclosure can be implemented in a non-transitory computer-readable medium storing code for wireless communications may include instructions executable by one or more processors to transmit, from a first AP to a second AP, a first individually addressed management frame, the first individually addressed management frame including an indication of at least one requested coordination scheme between the first AP and the second AP, the at least one requested coordination scheme associated with one or more coordinated restricted target wake time schedules, and the first individually addressed management frame further including an element that indicates a respective requested parameter set associated with each coordinated restricted target wake time schedule of the one or more coordinated restricted target wake time schedules, receive, from the second AP, a second individually addressed management frame including an indication of an acceptance of at least one coordinated restricted target wake time schedule of the one or more coordinated restricted target wake time schedules, and communicate one or more messages during one or more service periods of the at least one coordinated restricted target wake time schedule.

In some examples of the method, apparatuses, and non-transitory computer-readable medium described herein, transmitting the first individually addressed management frame may include operations, features, means, or instructions for transmitting, to the second AP, the first individually addressed management frame indicating a request that the second AP refrain from transmitting communications during the one or more coordinated restricted target wake time schedules, at a start of the one or more coordinated restricted target wake time schedules, or a combination thereof and receiving, from the second AP, a response to the first individually addressed management frame, where the response may be received prior to communicating the one or more messages.

In some examples of the method, apparatuses, and non-transitory computer-readable medium described herein, the at least one requested coordination scheme is of multiple coordination schemes, the multiple coordination schemes including a coordinated-restricted target wake time scheme, a coordinated-spatial reuse scheme, a coordinated-time division multiple access scheme, or any combination thereof.

In some examples of the method, apparatuses, and non-transitory computer-readable medium described herein, the element includes a coordination element, a target wake time element, or both.

In some examples of the method, apparatuses, and non-transitory computer-readable medium described herein, the second individually addressed management frame includes at least one flag indicating the at least one coordinated restricted target wake time schedule of the one or more coordinated restricted target wake time schedules.

Another innovative aspect of the subject matter described in this disclosure can be implemented in a method for wireless communications is described. The method may include receiving, from a first AP at a second AP, a first individually addressed management frame, the first individually addressed management frame including an indication of at least one requested coordination scheme between the first AP and the second AP, the at least one requested coordination scheme associated with one or more coordinated restricted target wake time schedules, and the first individually addressed management frame further including an element that indicates a respective requested parameter set associated with each coordinated restricted target wake time schedule of the one or more coordinated restricted target wake time schedules and transmitting, to the first AP, a second individually addressed management frame including an indication of an acceptance of at least one coordinated restricted target wake time schedule of the one or more coordinated restricted target wake time schedules.

Another innovative aspect of the subject matter described in this disclosure can be implemented in an apparatus for wireless communications that may include a processing system that includes processor circuitry and memory circuitry that stores code. The processing system may be configured to cause the apparatus to receive, from a first AP at a second AP, a first individually addressed management frame, the first individually addressed management frame including an indication of at least one requested coordination scheme between the first AP and the second AP, the at least one requested coordination scheme associated with one or more coordinated restricted target wake time schedules, and the first individually addressed management frame further including an element that indicates a respective requested parameter set associated with each coordinated restricted target wake time schedule of the one or more coordinated restricted target wake time schedules and transmit, to the first AP, a second individually addressed management frame including an indication of an acceptance of at least one coordinated restricted target wake time schedule of the one or more coordinated restricted target wake time schedules.

Another innovative aspect of the subject matter described in this disclosure can be implemented in an apparatus for wireless communications that may include means for receiving, from a first AP at a second AP, a first individually addressed management frame, the first individually addressed management frame including an indication of at least one requested coordination scheme between the first AP and the second AP, the at least one requested coordination scheme associated with one or more coordinated restricted target wake time schedules, and the first individually addressed management frame further including an element that indicates a respective requested parameter set associated with each coordinated restricted target wake time schedule of the one or more coordinated restricted target wake time schedules and means for transmitting, to the first AP, a second individually addressed management frame including an indication of an acceptance of at least one coordinated restricted target wake time schedule of the one or more coordinated restricted target wake time schedules.

Another innovative aspect of the subject matter described in this disclosure can be implemented in a non-transitory computer-readable medium storing code for wireless communications may include instructions executable by one or more processors to receive, from a first AP at a second AP, a first individually addressed management frame, the first individually addressed management frame including an indication of at least one requested coordination scheme between the first AP and the second AP, the at least one requested coordination scheme associated with one or more coordinated restricted target wake time schedules, and the first individually addressed management frame further including an element that indicates a respective requested parameter set associated with each coordinated restricted target wake time schedule of the one or more coordinated restricted target wake time schedules and transmit, to the first AP, a second individually addressed management frame including an indication of an acceptance of at least one coordinated restricted target wake time schedule of the one or more coordinated restricted target wake time schedules.

In some examples of the method, apparatus, and non-transitory computer-readable medium described herein, receiving the first individually addressed management frame may include operations, features, means, or instructions for receiving, from the first AP, the first individually addressed management frame indicating a request that the second AP refrain from transmitting communications during the one or more coordinated restricted target wake time schedules, at a start of the one or more coordinated restricted target wake time schedules, or a combination thereof.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows a hierarchical format of an example PPDU usable for communications between a wireless AP and one or more wireless STAs.

FIGS. 4A through 6 shows examples of signaling diagrams that illustrates communications between wireless devices to support access point transmission service period coordination.

FIG. 7 shows a block diagram of an example wireless communication device that supports access point transmission service period coordination.

FIGS. 8 and 9 show flowcharts illustrating example processes performable by or at a first wireless device that supports access point transmission service period coordination.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

In some wireless communication networks, access points (APs) may be configured with target wake times (TWTs) that determine parameters for APs to wake up to send and receive data. In some examples, a TWT configuration may enable APs and stations (STAs) to negotiate or coordinate times to access a wireless medium of a WLAN. Further, some APs may be configured with a restricted TWT (rTWT) that improves the network efficiency of the WLAN by reserving bandwidths for specific types of data traffic. For example, an AP may be associated with an rTWT for the transmission of latency-sensitive data traffic such that the AP may be able to negotiate sole access of the wireless medium to ensure relatively low levels of latency for data transmissions.

In some cases, APs may serve latency-sensitive data traffic. Latency-sensitive data traffic may be examples of communications (such as ultra-reliable low latency (UHRLLC) communications) that have a more stringent latency or Quality of Service (QoS) requirement than standard data traffic. For example, for video steaming, data traffic associated with relatively high latency may result in a decrease in quality. Thus, APs managing latency-sensitive traffic may be expected to ensure relatively low levels of latency to ensure transmission quality. In some examples, to improve the capability of an AP (such as a first AP) managing latency-sensitive data traffic, APs may coordinate with surrounding APs or neighboring APs on one or more service periods. As part of the coordination, the first AP may request for a second AP to terminate one or more transmission opportunities (TXOPs) as to refrain from interfering with the latency-sensitive traffic served by the first AP. Such coordination may be relatively simple in a managed environment as a controller can manage the APs. However, in an unmanaged environment, the first AP may be unable to have other APs refrain from transmitting one or more messages during one or more service periods. Therefore, the reliability and effectiveness of the first AP to serve latency-sensitive traffic may decrease.

Various aspects relate generally a first AP relatively more reliably and effectively serving latency-sensitive traffic based on the first AP performing a coordination procedure with other APs and STAs to negotiate a set of service periods for the first AP to serve latency-sensitive traffic. Some aspects more specifically relate to the first AP may transmitting one or more negotiation messages to other APs or STAs, as part of a coordination, to request that the APs or STAs refrain from or restrict transmitting at the start of one or more service periods, during the one or more service periods, or both. For example, a first AP may transmit, to a second AP, a first individually addressed management frame that includes an indication of at least one requested coordination scheme between the first AP and the second AP. In some implementations, the at least one requested coordination scheme may be associated with one or more coordinated restricted target wake time (C-rTWT) schedules. In such implementations, the first individually addressed management frame may further include an element that indicates a respective parameter set associated with each C-rTWT schedule of the one or more C-rTWT schedules. Additionally, or alternatively, the negotiation messages also may indicate one or more channel access parameters for the APs or STAs to apply during the one or more service periods to allow the first AP relatively better access to a wireless channel and enhance a capability of the first AP to serve latency-sensitive traffic. Further, a neighboring AP that agrees to refrain from or restrict transmitting during the one or more service periods of the first AP may transmit messages to the STAs connected with the neighboring AP, other APs, or both, indicating the one or more service periods of the first AP. For example, the first AP may receive, from the second AP, a second individually addressed management frame that includes an indication of an acceptance of at least one C-rTWT schedule indicated by the first individually addressed management frame. Therefore, the first AP may be capable of ensuring a relatively low level of interference, interruption, or collisions during the indicated one or more service periods, thus resulting in an increase in the effectiveness and reliability of the first AP to serve latency-sensitive traffic.

To further enable the first AP to more reliably and effectively serve latency-sensitive traffic, the first AP may indicate one or more schedules for the set of service periods that can be used for the first AP to serve the latency-sensitive traffic. For example, within coordination or negotiation messages (such as one or more individually addressed management frames), the first AP may indicate one or more schedules as being associated with service periods for serving latency-sensitive traffic, indicate one or more operations for the schedules, indicate target wake time (TWT) parameter sets, or any combination thereof. In some examples, the first AP may include such indications within additional fields of an element and can indicate via one or more bits of a control field whether the additional fields are present. In some other examples, the first AP may include the indications within a subfield of an information field of the element. For example, the first AP may indicate a requested coordination scheme associated with one or more C-rTWT schedules via an element of an individually addressed management frame that also indicates a respective parameter set for each C-rTWT schedule of the one or more C-rTWT schedules. In some implementations, to indicate whether schedules are for the first AP to perform latency-sensitive communications, the first AP may include a bitmap to indicate all the schedules together or include an indication per schedule via a subfield of an information field. Moreover, to indicate an operation of a respective schedule, the first AP may add an additional field for the indication or include the indication within a subfield of the information field. Additionally, or alternatively, to indicate TWT parameter sets, the first AP may indicate one or more TWT parameter sets within an additional field or the first AP may indicate a TWT element with a single TWT parameter set. Moreover, by including such schedule indications, the first AP may be capable of further ensuring a relatively low level of interference, interruption, or collisions during the indicated one or more service periods, thus resulting in an increase in the effectiveness and reliability of the first AP to serve latency-sensitive traffic.

Particular aspects of the subject matter described in this disclosure can be implemented to realize one or more of the following potential advantages. In some examples, by having a first AP negotiate one or more service periods for the transmission of latency-sensitive traffic, the described techniques may be used to enhance the capability of the first AP to perform latency-sensitive data transmissions. Moreover, the first AP transmitting an individually addressed management frame to a second AP to indicate at least one coordination scheme (such as a coordination scheme associated with one or more C-rTWT schedules) may enable the first AP to request the second AP to use a coordination scheme that allows or facilitates the first AP to perform latency-sensitive data transmissions relatively more efficiently. In accordance with a coordination scheme between the first AP and the second AP, the first AP and the second AP may coordinate respective transmissions to reduce the likelihood of inter-AP interference between the first AP and the second AP, which may enable latency-sensitive data transmissions by reducing the likelihood of a communication failure arising from interference. Further, in examples in which an indicated coordination scheme is associated with a C-rTWT schedule, the coordination scheme may enable latency-sensitive data transmissions by reserving one or more service periods for the latency-sensitive data and protecting the one or more service periods from transmissions by other devices (such as the second AP), which may enable transmission of the latency-sensitive data without interruption, which may in turn increase the efficiency and reliability of the latency-sensitive data.

Further, the negotiation procedures may enable other APs to accept, propose modifications, or deny the request from the first AP to refrain from transmitting communications during the indicated one or more service periods. For example, the second AP transmitting an individually addressed management frame to the first AP indicating an acceptance of a C-rTWT schedule may ensure that that the first AP and the second AP are synchronized according to the coordination scheme being used, which may result in relatively more efficient and reliable communications. Moreover, due to the first AP and the second AP being synchronized, the first AP and the second AP may utilize, for example, a same coordination scheme that is associated with a C-rTWT schedule that corresponds to one or more service periods during which the first AP may transmit latency-sensitive data. In accordance with the first AP and the second AP being synchronized and utilizing the same coordination scheme, the second AP may refrain from performing any communications during the one or more service periods that are associated with the coordination scheme. Thus, the synchronization of a coordination scheme between the first AP and the second AP may ensure that the first AP can transmit the latency-sensitive data with a relatively low amount of interference from the second AP, which may result in greater communication efficiency and reliability. Additionally, or alternatively, having indications associated with schedules for the one or more service periods (such as C-rTWT schedules) that the first AP may use to perform latency-sensitive data transmissions may ensure additional coordination between the first AP and the other APs and STAs to prevent service interruptions during the one or more service periods. For example, having the first AP indicate schedules as being associated with the service periods for latency-sensitive communications, indicate operations for the schedules, indicate TWT parameter sets (such as parameter sets associated with C-rTWT schedules), or any combination thereof may ensure that each other wireless device coordinated by the first AP is capable of refraining from interrupting the one or more service periods. Therefore, the first AP may be capable of ensuring a decrease in the latency of latency-sensitive traffic to provide a more robust, efficient, and reliable wireless communications system.

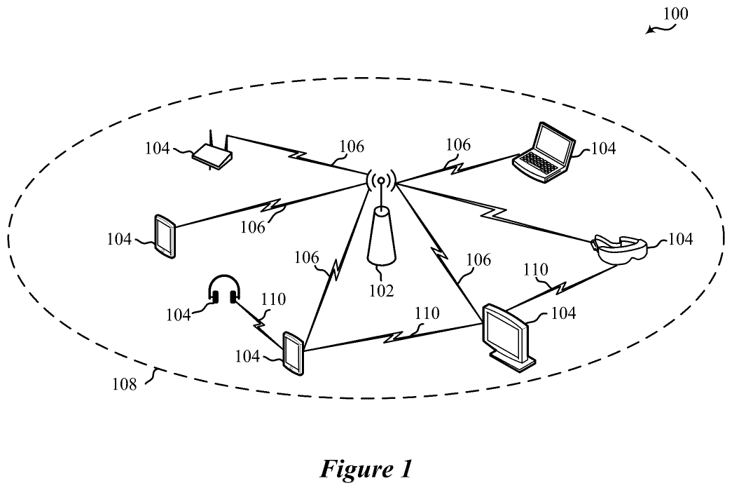

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11 bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

In some examples, the AP 102 or the STAs 104 of the wireless communication network 100 may implement Extremely High Throughput (EHT) or other features compliant with current and future generations of the IEEE 802.11 family of wireless communication protocol standards (such as the IEEE 802.11be and 802.11bn standard amendments) to provide additional capabilities over other previous systems (such as High Efficiency (HE) systems or other legacy systems). For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT and newer wireless communication protocols (such as the protocols referred to as or associated with the IEEE 802.11bn standard amendment) may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

In some examples of the wireless communication network 100, wireless devices (such as APs 102 and STAs 104) may utilize a coordinated restricted target wake time (C-rTWT) to enhance the ability of APs to serve latency-sensitive traffic. Therefore, coordinated APs may respect and follow the parameters of service periods associated with a coordinating. In some examples, the framework for TWT may include several components. For example, an individual frame exchange may be used to set up a TWT membership in broadcast TWT agreements or to perform negotiation for individual TWT agreements. Further, a scheduling component may be used to provide TWT schedules in broadcast TWT agreements. Moreover, individual TWT agreements may be used for power save purposes as the one-to-one nature of the agreement is for specific STA power save requirements. In some examples, the C-rTWT operations may include a broadcast component similar to the broadcast component of rTWT operations from APs 102 to the associated STAs 104 of an AP 102, to effectively provide prioritization to the coordinating AP 102 at the beginning of a C-rTWT service period. Additionally, or alternatively, broadcast TWT agreements may be used for rTWT agreements, with the membership-based nature of the agreement being for the sake of a group of STAs 104 terminating their TXOP at pre-determined times to allow for an AP 102 to easily access the channel and serve latency-sensitive traffic. The TWT framework may be further reused in C-rTWT to support the propagation of agreements in beacon transmissions to STAs 104 associated with coordinated APs 104. Thus, the described rTWT agreements may be built on top of existing broadcast TWT agreements.

In some examples, the coordination of APs 102 in an unmanaged Ultra-High Reliability (UHR) deployment may be relatively difficult. While a controller may coordinate the APs in a managed UHR deployment, infrastructure APs 102 (infra-APs 102) or software APs 102 (softAPs 102) may refrain from following the parameters of an rTWT for an AP in an unmanaged UHR environment. For example, if a transmission opportunity (TXOP) of a second AP 102 is ongoing, a first AP 102 may be unable to access the medium of a WLAN to serve latency-sensitive traffic during a rTWT SP, thus disrupting the flow of latency-sensitive traffic. Additionally, or alternatively, clients of the first AP 102, such as a first STA 104, may be hidden from the second AP 102, leading the second AP 102 to unnecessarily terminate one or more TXOPs before the service periods of the first AP 102. In some examples, the premature termination of TXOPs may lead to inefficiencies within the wireless communication network 100 such as increases in latency of communications. In some examples, the first AP 102 and the second AP 102 may both manage to access the medium (such as beyond the ED range) resulting in overlapping transmissions which can degrade the Packet Error Rate (PER). Therefore, the first AP 102 may experience decreases in reliability and efficiency when serving latency-sensitive traffic, thus reducing the efficiency and reliability of the wireless communication network 100.

To prevent a reduction in the efficiency and reliability of the wireless communication network 100, a framework of individual and broadcast TWT agreements may be enhanced to enable a robust and efficient wireless communication network 100 that can effectively handle latency-sensitive traffic. To enable relatively more effective handling of latency-sensitive traffic, a coordination mechanism between APs 102 may be configured to coordinate respective service periods for latency-sensitive data transmissions. In some examples, the coordinated medium access for APs 102 in UHR may leverage hooks introduced in enhanced high throughput (EHT) as rTWT. Therefore, STAs may terminate their TXOPs before the start time of an rTWT service period such that an AP 102 can access the medium to serve latency-sensitive traffic. In some examples, for UHR, a set of APs 102 may coordinate to respect and follow service periods of an AP 102. This coordination scheme between APs may facilitate the transmissions of participating APs at the start of their respective service periods to reliably serve latency-sensitive traffic. For example, the coordination between the wireless devices may instruct a first STA 104 and a second AP 102 to their TXOP and facilitate the medium access of a first AP 102 at the of a service period associated with the AP 102, thus allowing for a more efficient and reliable flow of latency-sensitive traffic. Additionally, or alternatively, APs 102 may end Basic Service Set (BSS) transmissions before the coordinated service periods, to avoid delayed access at the start of the coordinated service period. Further, ending BSS transmissions also may reduce the chance of overlapped transmissions between APs 102, thereby enhancing the efficiency of the wireless communication network 100.

In some implementations, the wireless communication network 100 may include an AP 102 that serves to latency-sensitive traffic. This traffic may include ultra-low-latency (ULL) gaming, streaming lossless audio and video to one or more STAs 104, or any other type of applications that expect ULL and high throughput. To ensure the reliable and effective delivery of this latency-sensitive traffic, the AP 102 may execute a coordination procedure with other APs and STAs 104 to negotiate a set of service periods. The AP 102 may transmit one or more negotiation messages to other APs 102 or STAs 104, requesting that the other APs 102 or STAs 104 refrain from or restrict transmitting at the start of one or more service periods, during the one or more service periods, or both. For example, a first AP 102 may transmit a first individually address management frame to a second AP to indicate a requested coordination scheme between the first AP 102 and the second AP 102, the requested coordination scheme being associated with one or more C-rTWT schedules. In some implementation, the first individually addressed management frame may also include an element that indicates a respective parameter set for each C-rTWT schedule of the one or more C-rTWT schedules. The negotiation messages also may indicate one or more channel access parameters for the APs 102 or STAs 104 to implement during the one or more service periods to allow the AP 102 better access to the wireless channel and enhance the capability of the AP 102 to serve latency-sensitive traffic by ensuring a relatively low level of interference, interruption, or collisions during the indicated one or more service periods.

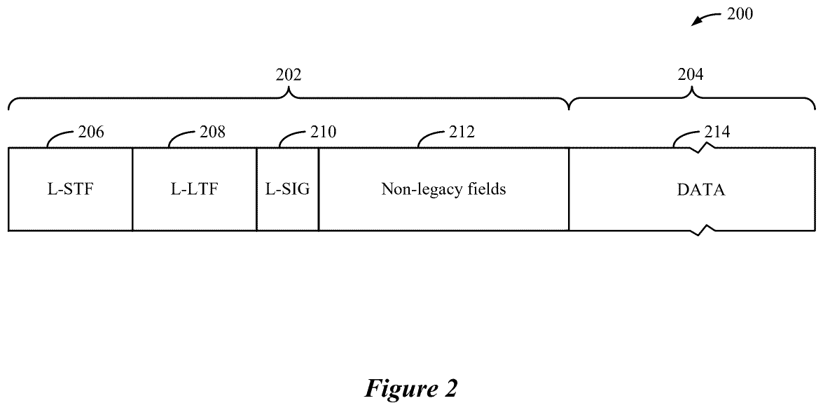

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

In some examples, the PDU 200 may be utilized in a coordination procedure performed by a first AP to negotiate a set of service periods for serving latency-sensitive traffic. The PDU 200 may carry one or more first messages (such as negotiation messages or a first individually addressed management frame) transmitted by the first AP to other APs (such as a second AP) or STAs. The one or more negotiation messages may indicate at least one requested coordination scheme where the APs (such as the second AP) or STAs refrain from or restrict transmitting at the start of one or more service periods, during the one or more service periods, or both. The one or more negotiation messages also may include an element that indicates a respective parameter set for the requested coordination scheme. In some implementations, a negotiation message may also include one or more channel access parameters for the APs or STAs to apply during the one or more service periods to allow the first AP better access to the wireless channel and enhance a capability of the first AP to serve latency-sensitive traffic. For example, the first AP may ensure a relatively low level of interference during one or more service periods associated with a C-rTWT schedule, that corresponds to the coordination scheme, which can improve the performance of latency-sensitive data transmissions based on requesting, via the coordination scheme, that the second AP refrain from communicating during the one or more service periods. Thus, because the second AP may refrain from communicating during the one or more service periods, the first AP may transmit the latency-sensitive data transmissions without interruption, which may improve the efficiency and reliability of the latency-sensitive data transmissions.

Moreover, the second AP transmitting an individually addressed management frame to the first AP indicating an acceptance of a C-rTWT schedule may ensure that that the first AP and the second AP are synchronized according to the coordination scheme being used, which may result in relatively more efficient and reliable communications. For example, due to the first AP and the second AP being synchronized, the first AP and the second AP may utilize a same coordination scheme (such as a coordination scheme that is associated with a C-rTWT schedule that indicates one or more service periods during which the first AP may transmit latency-sensitive data). Further, based on the first AP and the second AP being synchronized and utilizing the same coordination scheme, the second AP may refrain from transmitting any communications during one or more service periods, associated with the coordination scheme, being used by the first AP for latency-sensitive data transmissions. Thus, the synchronization of a coordination scheme between the first AP and the second AP may ensure that the first AP can transmit the latency-sensitive data transmissions with a relatively low level interference from the second AP, which can result in improved communication efficiencies and reliability.

In some examples, the payload 204 of the PDU 200, which may include a PSDU including the DATA 214, may carry the one or more negotiation messages (the payload 204 of the PDU 200 may include the individually addressed management frame from a first AP to a second AP). Further, the DATA 214 may carry higher layer data, for example, in the form of MPDUs or an A-MPDU to indicate the one or more negotiation messages. Therefore, the PDU 200 may enable the first AP the capability of ensuring relatively low level of interference, interruption, or collisions during the indicated one or more service periods, thus resulting in an increase in the effectiveness and reliability of the first AP to serve latency-sensitive traffic.

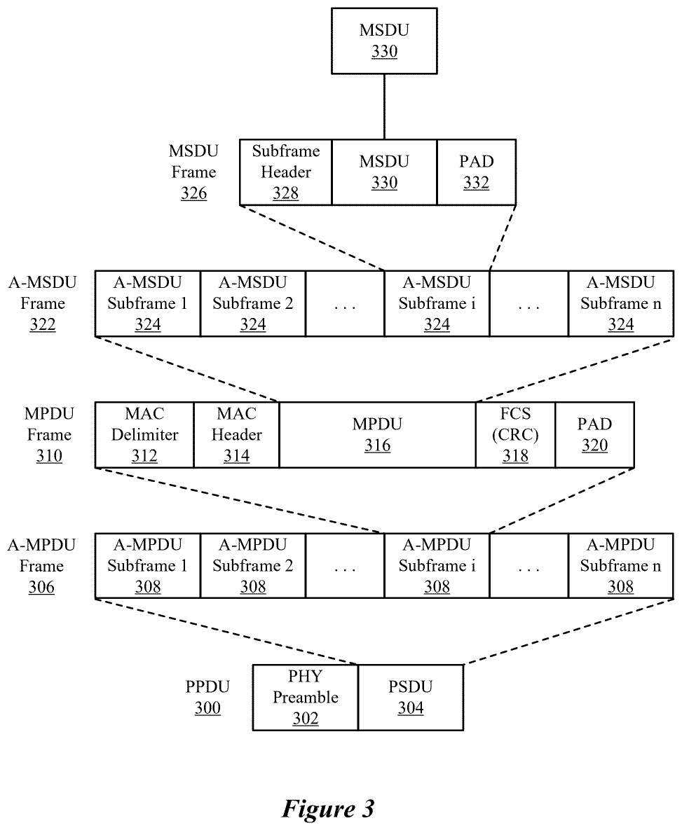

FIG. 3 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 308 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (such as the FCS field 318 may include a cyclic redundancy check (CRC)) and padding bits 320. The MPDU 316 may carry one or more MAC service data units (MSDUs) 330. For example, the MPDU 316 may carry an aggregated MSDU (A-MSDU) 322 including multiple A-MSDU subframes 324. Each A-MSDU subframe 324 may be associated with an MSDU frame 326 and may contain a corresponding MSDU 330 preceded by a subframe header 328 and, in some examples, followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body. The MAC header 314 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 314 also includes one or more fields indicating addresses for the data encapsulated within the frame body. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (such as the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples, in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of unmanaged or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

Retransmission protocols, such as hybrid automatic repeat request (HARQ), also may offer performance gains. A HARQ protocol may support various HARQ signaling between transmitting and receiving wireless communication devices (such as the AP 102 and the STAs 104 described with reference to FIG. 1) as well as signaling between the PHY and MAC layers to improve the retransmission operations in a wireless communication network. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a wireless communication network may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (such as a negative acknowledgment (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHz, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (such as one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (such as switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

The aforementioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

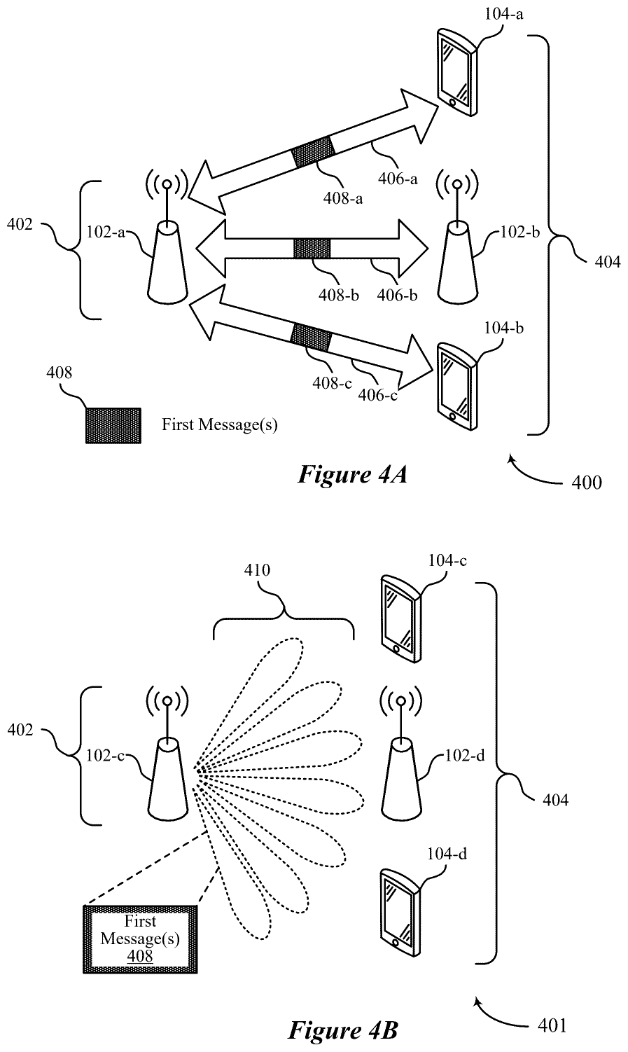

In some examples, a first wireless device (such as an AP) may transmit one or more PPDUs 300, to one or more second wireless devices (such as other APs and STAs) to indicate one or more service periods and one or more channel access parameters to apply during the one or more service periods in accordance with the techniques of the present disclosure. Further, the one or more PPDUs 300 may request that the one or more second wireless devices cancel one or more TXOPs prior to the start of the one or more service periods and refrain from initiating TXOPs during the one or more service periods. For example, the one or more PPDUs 300 may include a first individually addressed management frame from a first AP for a second AP that indicates at least one requested coordination scheme between the first AP and the second AP. In some implementations, the at least one requested coordination scheme may be associated with one or more C-rTWT schedules and the first individually addressed management frame may include an element indicating respective parameter sets for each C-rTWT schedule of the one or more C-rTWT schedules. Thus, the PPDUs 300 may include a requested coordination scheme, and a parameter set associated with the requested coordination scheme. Moreover, the one or more channel access parameters may include EDCA parameters for the one or more second wireless devices to apply during the one or more service periods. The EDCA parameters indicated via the one or more channel access parameters may enable the first wireless device the capability to more easily contend for the access to the wireless medium of a WLAN over the one or more second wireless devices. Further, APs may transmit the one or more PPDUs 300 as part of a coordinated communication scheme that allows a first AP that is transmitting latency-sensitive traffic a higher chance of “winning” the contention of the wireless medium for one or more TXOPs. The TXOPs may be used by the first wireless device to transmit latency-sensitive PPDUs 300 such as XR data packets or data packets related to cloud computing. Therefore, by requesting the cancellation and refrain of the TXOPs of the one or more second wireless devices, the first wireless device may be capable of ensuring reliable transmissions of the latency-sensitive PPDUs 300. Further descriptions of the first wireless device performing coordination with one or more second wireless devices for the transmission of latency-sensitive PPDUs in accordance with the techniques of the present disclosure may be describe elsewhere herein, such as with reference to FIGS. 4A through 6.

FIG. 4A shows an example of a signaling diagram 400 that supports access point transmission service period coordination. The signaling diagram 400 may implement or be implemented to realize one or more aspects of the wireless communication network 100. For example, the signaling diagram 400 illustrates communications between one or more APs 102 (such as between an AP 102-a and an AP 102-b) and communications between the APs 102 (such as the AP 102-a) and one or more STAs (such as a STA 104-a and a STA 104-b), as illustrated by and described with reference to FIG. 1. In some implementations, the AP 102-a may be referred to as a first wireless device 402 and the AP 102-b, the STA 104-a, and the STA 104-b may be referred to as one or more second wireless devices 404. Further, the first wireless device 402 may communicate with the one or more second wireless device 404 via one or more communication links 406 (such as a communication link 406-a, a communication link 406-b, and communication link 406-c) which may be examples of a communication link 106 as illustrated by and described with reference to FIG. 1.

In some examples, APs 102 may exchange frames (such as one or more first messages 408) to establish and coordinate one or more service periods (such as C-rTWT service periods) with other wireless devices (such as other APs 102 and STAs 104) for latency-sensitive data transmissions. For example, the AP 102-a may transmit one or more first messages 408 to one or more second wireless device 404 (such as the AP 102-b, the STA 104-a, and the STA 104-b) to have the one or more second wireless devices 404 interrupt one or more TXOPs or otherwise restrict or modify transmissions before the start of a first service period of the one or more service periods. In some implementations, the AP 102-a may be referred to as a coordinating AP 102 as the AP 102-a may initiate the frame exchange and the AP 102-b may be referred to as a coordinated AP 102 as the AP 102-b may receive and follow the service period coordination indicated via the frame exchange. In some other implementations, the AP 102-b may be the coordinating AP 102 and the AP 102-a may the coordinated AP 102.

In some examples, the coordinating AP 102-a may transmit the one or more first messages 408 (such as a first individually addressed management frame) to both the coordinated AP 102-b and to the STA 104-a and the STA 104-b that are connected to the coordinating AP 102-a. Therefore, the coordinating AP 102-a may request that both neighboring APs 102 (such as the AP 102-a) and the STAs 104 connected to the coordinating AP 102-a follow the schedule of the one or more service periods indicated via the one or more first messages 408. In some examples, the coordinating AP 102-a may individually transmit the one or more first messages 408 to each of the one or more second wireless devices 404. Therefore, the frame exchange of the one or more first messages 408 may include the coordinating AP 102-a targeting individual agreements (such as individual C-rTWT agreements) with the one or more second wireless devices 404. In some examples, the individual agreements may include the coordinating AP 102-a transmitting individually addressed management frames to establish the agreement with a respective second wireless device of the one or more second wireless devices 404. For example, to transmit the one or more first messages 408, which may be or may include individually addressed management frames, the coordinating AP 102-a may transmit, a first message 408-a to the STA 104-a via a communication link 406-a, a first message 408-b to the coordinated AP 102-b via a communication link 406-b, a first message 408-c to the STA 104-b via a communication link 406-c, or any combination thereof. Additionally, or alternatively, the first message 408-a, the first message 408-b, and the first message 408-c, may include the same information or different information based on the wireless device for which the respective first message of the one or more first messages 408 is intended.

In some examples, the messages exchanged between the first wireless device 402 and the one or more second wireless devices 404 (such as the one or more first messages 408) may be used for negotiating the schedule of the one or more service periods and for negotiating the one or more channel access parameters for the one or more second wireless devices 404 to apply during the indicated one or more service periods. For example, in some examples, the coordinating AP 102-a may transmit the one or more first messages 408 requesting that the one or more second wireless devices 404 refrain from transmitting communications during the indicated one or more service periods, at the start of the indicated one or more service periods, or both. In some implementations, the one or more first messages 408, which may be or may include individually addressed management frames, may indicate a requested coordination scheme between the coordinating AP 102-a and the coordinated AP 102-b. In some examples, the first wireless device 402 may receive, prior to communicating one or more second messages during the one or more service periods, a third message from the one or more second wireless devices 404 indicating a response to the one or more first messages 408. In some implementations, the response to the one or more first messages 408 may indicate an acceptance to refrain from transmitting communications during the indicated one or more service periods in accordance with the indicated one or more channel access parameters. For example, the coordinated AP 102-b may transmit, to the coordinating AP 102-a via a second individually addressed management frame, an indication of an acceptance of at least one schedule (such as a C-rTWT schedule) that is associated with the at least one requested coordination scheme between the coordinating AP 102-a and the coordinated AP 102-b indicated via the first individually addressed management frame from the coordinating AP 102-a. That is, the one or more second wireless devices 404 may accept the request from the first wireless device 402 to apply the one or more channel access parameters during the indicated one or more service periods. In some implementations, the second individually addressed management frame may include at least one flag indicating the at least one coordinated restricted target wake time schedule of the one or more coordinated restricted target wake time schedules to indicate the acceptance.

In some other implementations, the response to the one or more first messages 408 may indicate a proposed modification of the request. For example, the one or more second wireless devices 404 may propose to adjust the timing of the indicated one or more service periods, adjust the indicated one or more channel access parameters, or both. In some examples, the proposal message may also indicate that if the proposal is not accepted, the one or more second wireless devices 404 may accept the original request indicated in the one or more first messages 408. In some other examples, the proposal message may indicate that the one or more second wireless devices 404 may reject the request of the one or more first messages 408 if the proposal is not accepted. Additionally, or alternatively, the first wireless device 402 may transmit a message in response to the proposal message to propose alternatives (such as alternative timings, alternative channel access parameters, or a combination thereof) to the proposal for the one or more second wireless devices 404. For example, the proposal message from the one or more second wireless devices 404 may indicate that a subset of the one or more channel access parameters are acceptable and propose changes to the remaining one or more channel access parameters. Therefore, the first wireless device 402 may respond to the proposal either accepting the request from the one or more second wireless devices 404 and the one or more channel access parameters indicated by the one or more second wireless devices 404, proposing alternative channel access parameters, or rejecting the proposal. Thus, the first wireless device 402 and the one or more second wireless devices 404 may continue to exchange message frames until both the first wireless device 402 and the one or more second wireless devices 404 are in agreement on a coordination schedule.

Additionally, or alternatively, the response to the one or more first messages 408 may indicate a rejection or refusal to refrain from transmitting communications during the indicated one or more service periods in accordance with the channel access parameters. In other words, the response to the one or more first messages 408 may indicate a rejection of at least a subset of the indicated (such as requested) TWT schedules. Further, it should be understood that either the coordinating AP 102-a or the coordinated AP 102-b may communicate such indications. For example, in some implementations, the coordinated AP 102-b may request to join a coordination schedule (such as TWT) with the coordinating AP 102-a without specifying a target wake time. In some other implementations, the AP 102-b may request to join a coordination schedule with the coordinating AP 102-a and suggest a set of one or more channel access parameters for the coordinated AP 102-b to apply during the one or more service periods. Further, the request from the coordinated AP 102-b also may indicate that if the coordinating AP 102-a refrains from accepting the suggestions (such as a requested target wake time, a set of one or more channel access parameters, or both), the coordinated AP 102-b may still request to join the coordination. Moreover, the coordinated AP 102-b may request the join the coordination schedule with the coordinating AP 102-a and indicate a set of one or more channel access parameters that if not accepted by the coordinating AP 102-a, the coordinated AP 102-b may refrain from joining the coordination schedule.

Further, the coordinating AP 102-a may respond to the requests from the coordinated AP 102-b. In some examples, the coordinating AP 102-a may respond to the request by accepting the request of the coordinated AP 102-b and accepting the one or more channel access parameters indicated by the coordinated AP 102-b (such as indicated via a TWT element transmitted by the coordinated AP 102-b). In some implementations, the value of the acceptance message may be used to create an establish an unsolicited coordination agreement (such as an unsolicited C-rTWT agreement). Further, in the case of an unsolicited agreement, the coordinating AP 102-a may transmit an indication of the one or more service periods to be coordinated. In some cases, the coordinating AP 102-a may also transmit an indication of one or more channel access parameters for the coordinated AP 102-b to apply within the same frame or message that carries the acceptance or in a separate frame after establishing the coordination agreement. In some other implementations, the coordinating AP 102-a may respond to the coordinated AP 102-b suggesting alternative channel access parameters that are different than the one or more channel access parameters indicated by the coordinated AP 102-b. Therefore, the coordination may be unestablished and the coordinating AP 102-a may propose alternative channel access parameters that would be acceptable to the coordinating AP 102-a along with an indication that other channel access parameters can be accepted by the coordinating AP 102-a. In other implementations, the coordinating AP 102-a may respond to the coordinated AP 102-b requesting to join the coordination by dictating one or more channel access parameters that are different than the one or more channel access parameters indicated by the coordinated AP 102-b. Moreover, the alternative channel access parameters indicated by the coordinating AP 102-a may indicate the one or more channel access parameters acceptable to the coordinating AP 102-a and the response indicates that the coordinating AP 102-a will reject any other channel access parameters. Additionally, or alternatively, the coordinating AP 102-a may reject the request from the coordinated AP 102-b to setup the coordination.

In some implementations, the one or more channel access parameters indicated by the coordinating AP 102-a via the one or more first messages 408 or requested by the coordinated AP 102-b may include additional EDCA parameters for the one or more second wireless devices 404 to apply during the one or more service periods. In some examples, to extend a message (such as a TWT element including up to N TWT parameter sets) an element extension may be used to host up to N parameter sets. Therefore, the coordinating AP 102-a may be capable of indicating additional channel access parameters via the one or more first messages 408. For example, the one or more first messages 408 that may be individually addressed may be capable of indicating one or more sets of one or more channel access parameters. To indicate a respective channel access parameter set, a parameter set extension of a respective first message of the one or more first messages 408 may include a pair channel access parameter set identifier (ID) (such as a pair TWT ID) that is associated with a corresponding channel access parameter set (such as a TWT parameter set). Further, the channel access parameter ID may follow a one-to-one agreement where each possible channel access parameter set is associated with individual and unique IDs. In some examples, the parameters indicated in a respective channel access parameter set may be EDCA parameters that are normally provided to STAs 104 via an EDCA parameter element. Further, the channel access parameter set extension of the one or more first messages 408 may enable the coordinating AP 102-a the capability of indicating specific EDCA parameters for the one or more second wireless devices 404 to apply and use to access the medium of a WLAN during the one or more indicated service periods.

In some implementations, the one or more first messages 408 may include an indicator (such as a single bit) to indicate a type of coordination agreement related to a respective channel access parameter set (such as a C-rTWT agreement). For example, the one or more first messages 408 may indicate a requested coordination scheme between the coordinating AP 102-a and the coordinated AP 102-b. Further, the one or more channel access parameters indicated in a respective channel access parameter set may include an indication of a coordination scheme between the coordinating AP 102-a and the coordinated AP 102-b. The indication of the coordination scheme may provide a level of protection, an indication of a type of coordination, or both. In some implementations, the requested coordination scheme may also be associated with one or more C-rTWT schedules and the one or more first messages 408 may include a respective parameter set for each C-rTWT schedule of the one or more C-rTWT schedules. For example, C-rTWT may be an option as a type of coordination along with coordinated-spatial reuse (C-SR) and coordinated-TDMA (C-TDMA) which be capable of piggybacking. Further, the indication of the coordination scheme may indicate the behavior for coordinated APs 102 (such as C-rTWT behavior), the protection for coordinated APs 102 and the STAs 104 associated with the coordinated APs 102, a C-SR scheme, a C-TDMA for TXOP sharing, or any combination thereof.

For example, when the coordinating AP 102-a transmits individually addressed one or more first messages 408, respective first messages may be examples of individually addressed management frames. In some examples, an individually addressed management frame may include an element (such as a TWT element) and an element extension (such as a TWT element extension). Further, the element may indicate a parameter set for a respective ID K, a single parameter set in the element (such as a TWT parameter set for a TWT ID K). Moreover, the element extension may indicate a parameter set extension for a respective ID K, a single set in the element extension (such as a TWT parameter set extension for the TWT ID K). Therefore, STAs 104 (such as the STA 104-a and the STA 104-b) or coordinated APs 102 (such as the coordinated AP 102-b) that agree to the requests indicated via the one or more first messages 408 may apply, during the indicated one or more service periods, a respective parameter set associated with a parameter set ID K that is indicated via the one or more first messages 408.

In some implementations, coordinating AP 102-a may coordinate with the one or more second wireless devices 404 via different schemes (such as C-rTWT, C-SR, C-TDMA), the coordinating AP 102-a may exchange frames indicating one or more capabilities of the coordinating AP 102-a. For example, the coordinating AP 102-a may transmit a message or frame, separate from and prior to transmitting the one or more first messages 408, to support a unified coordination framework. In some implementations, the frame may indicate the MAC ID of the coordinating AP 102-a, whether a response is expected from the one or more second wireless devices 404 (such as a level 2 ACK (L2 ACK) or capability frame), an indication of one or more capabilities of the coordinating AP 102-a, or any combination thereof. Further, the indication of the one or more capabilities may include an indication of a C-rTWT capability, a C-SR capability, a C-TDMA capability, or any combination thereof.

Additionally, or alternatively, inter-APs 102 may expect secure messaging for inter-AP 102 messages for coordination (such as for C-rTWT agreements). For a proprietary or managed environment, APs 102 may guarantee security and secure messaging via one or more protocols when respective APs 102 are members of the same ESS. Therefore, if the coordinating AP 102-a is within the same ESS as the coordinated AP 102-b, the coordinating AP 102-a may trust the messages from the coordinated AP 102-b, and vice versa, due to being within the same ESS. For non-cooperative or unmanaged deployments APs 102 may establish security and secure messaging via an AP PeerKeys protocol. The AP PeerKeys protocol may include the coordinating AP 102-a and the coordinated AP 102-b sharing public keys to generate and obtain a common key for the coordinating AP 102-a and the coordinated AP 102-b. Therefore, the coordinating AP 102-a may transmit encrypted messages via the AP PeerKeys protocol to exchange messages with the coordinating AP 102-a to coordinate with APs 102 that are part of different ESSs. Further, in some implementations, the coordinating AP 102-a may associate the public key received from the coordinated AP 102-b, that is received for the first time from the coordinated AP 102-b, with the MAC address of the coordinated AP 102-b. Therefore, all subsequent session key establishments with the coordinated AP 102-b may be verified due to a one-to-one mapping between the public key and the MAC address of the coordinated AP 102-b. Thus, the coordinating AP 102-a may prevent impersonation attacks as the correct AP 102 should have the correct public key (such as a public key that is a pair with a private key of the associated AP 102). That is, when the first wireless device 402 receives the public key from the one or more second wireless devices 404, the first wireless device 402 may associate the public key of the one or more second wireless devices 404 with an ID (such as the MAC address) of the one or more second wireless devices 404.

In some implementations, to establish trust between two or more APs 102, the coordinating AP 102-a and the coordinated AP 102-b may use a third-party cloud-based entity. Further, the third-party entity may be a trusted entity for both the coordinating AP 102-a and the coordinated AP 102-b. For example, the coordinating AP 102-a and the coordinated AP 102-b may use the third-party entity to receive certificates that are signed by the trusted third-party entity. Therefore, the coordinating AP 102-a and the coordinated AP 102-b may present and share the signed certificates when communicating and if the certificates are signed by a third-party entity that is trusted by both the coordinating AP 102-a and the coordinated AP 102-b, the coordinating AP 102-a and the coordinated AP 102-b may trust communications from each other. In some examples, the trusted third-party may also be a back-end controller that provides signed certificates to APs 102 to enable APs 102 the capability of authenticating other APs 102. For example, the first wireless device 402 may receive, from a trusted entity, a first certificate that is signed by the trusted entity. The first wireless device 402 may also receive, from the one or more second wireless devices 404, a second certificate that is signed by the trusted entity such that the first certificate and the second certificate are both signed by the same trusted entity. Moreover, the first wireless device 402 may transmit the one or more first message 408 to the one or more second wireless devices 404 based on the first certificate and the second certificate both being signed by the same trusted entity. Additionally, or alternatively, the coordinating AP 102-a and the coordinated AP 102-b may share public keys and obtain the common key based on the authentication provided by signed certificates of a trusted entity.

Thus, the techniques of the present disclosure may enable the first wireless device 402 in coordinating with the one or more second wireless devices 404 on a coordination scheme between the first wireless device 402 and the one or more second wireless devices 404 to allow relatively seamless communications of latency-sensitive traffic. For example, as described herein and in accordance with the techniques of the present disclosure, the first wireless device 402 may indicate, via a first individually addressed management frame, a requested coordination scheme that is associated with one or more C-rTWT schedules, where the coordination scheme is between the first wireless device 402 and a respective second wireless devices 404. Further, the first wireless device 402 may indicate parameter sets for each of the one or more C-rTWT schedules. In response, the respective second wireless device 404 may indicate, to the first wireless device 402 via a second individually addressed management frame, an indication of an acceptance of at least one of the C-rTWT schedules (such that the first wireless device 402 can communicate one or more messages during one or more service periods of the accepted C-rTWT schedule). Moreover, due to the coordination performed between the first wireless device 402 and the respective second wireless device 404 and via the individually addressed management frames, the first wireless device 402 may be support latency-sensitive traffic relatively more efficient and reliably. In some examples, the first wireless device 402 may transmit the one or more first messages 408 via a broadcast message, a group addressed message, or a beacon frame to reduce the signaling overhead. For example, opposed to transmitting the first message 408-a, the first message 408-b, and the first message 408-c, the first wireless device 402 may be capable of transmitting a single group addressed messages to coordinate with the one or more second wireless devices 404. Further descriptions of broadcast or group-addressed based coordination in accordance with the techniques of the present disclosure may be described elsewhere herein, such as with reference to FIG. 4B.

FIG. 4B shows an example of a signaling diagram 401 that supports access point transmission service period coordination. The signaling diagram 401 may implement or be implemented to realize one or more aspects of the wireless communication network 100. For example, the signaling diagram 401 illustrates communications between one or more APs 102 (such as between an AP 102-c and an AP 102-d) as illustrated by and described with reference to FIG. 1 and communications between the APs 102 (such as the AP 102-c) and one or more STAs (such as a STA 104-c and a STA 104-c) as illustrated by and described with reference to FIG. 1. In some implementations, the AP 102-c may be referred to as a first wireless device 402 and the AP 102-d, the STA 104-c, and the STA 104-d may be referred to as one or more second wireless devices 404. Further, the first wireless device 402 may communicate with the one or more second wireless device 404 via one or more communication links 406 which may be examples of a communication link 106 as illustrated by and described with reference to FIG. 1.

In some examples, APs 102 may exchange frames (such as one or more first messages 408) to establish and coordinate one or more service periods (such as C-rTWT service periods that may be used to improve the capability of a respective AP 102 to serve latency-sensitive traffic) with other wireless devices (such as other APs 102 and STAs 104) for latency-sensitive data transmissions. For example, the AP 102-c may transmit one or more first messages 408 to one or more second wireless device 404 (such as the AP 102-d, the STA 104-c, and the STA 104-d) to have the one or more second wireless devices 404 interrupt one or more TXOPs before the start of a first service period of the one or more service periods. In some implementations, as illustrated and described herein, the AP 102-c may be referred to as a coordinating AP 102 as the AP 102-c may initiate the frame exchange and the AP 102-d may be referred to as a coordinated AP 102 as the AP 102-d may receive and follow the service period coordination indicated via the frame exchange. For example, within a respective C-rTWT service period, the AP 102-d which may be the coordinated AP 102 may respect the C-rTWT service period of the AP 102-c that may be the coordinating AP 102 such that a respective communication channel is idle for the EDCA of AP 102-c at the beginning of a respective C-rTWT service period. In some other implementations, the AP 102-d may be the coordinating AP 102 and the AP 102-c may be the coordinated AP 102.

As illustrated herein, the coordinating AP 102-c may transmit the one or more first messages 408 to the one or more second wireless devices 404 by transmitting a first group-addressed message. The first group addressed message may indicate the one or more service periods associated with the coordinating AP 102-a and the one or more channel parameters for the one or more second wireless devices 404 to apply during the one or more service periods associated with the coordinating AP 102-a. Further, a subset of the one or more second wireless devices 404 may be connected to the coordinating AP 102-a. For example, the coordinating AP 102-c may be an AP 102 for the STA 104-c and the STA 104-d. Therefore, the coordinating AP 102-a may be capable of transmitting the indication of the one or more service periods and the one or more channel access parameters to multiple wireless devices via a single group addressed message.

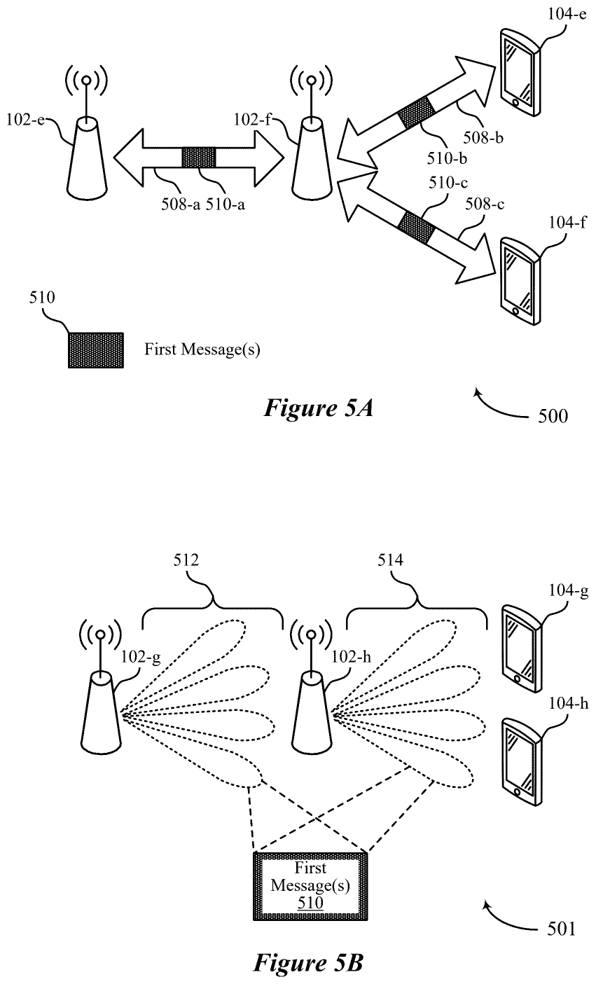

Further, the one or more first messages 408 transmitted via the first group addressed message may be for broadcast-based coordination agreements (such as a broadcast C-rTWT (b-C-rTWT) agreement). For broadcast-based agreements, the coordinating AP 102-c may transmit individually addressed frames to a coordinated AP 102-d to establish the membership of the coordinated AP 102 to a broadcast coordination group (such as a b-C-rTWT coordination group). Following establishing the membership of the coordinated AP 102-d, the coordinating AP 102-c may transmit broadcast frames (such as the one or more first messages 408) via a beacon frame to inform the coordinated AP 102-d of the coordination schedule and the associated parameters (the one or more service periods and the one or more channel access parameters for the coordinated AP 102-d to apply during the one or more service periods). Further, the coordinating AP 102-c may transmit the beacon frame via one or more beams 410 at the coordinating AP 102-c to transmit the one or more first messages 408 in a broadcast manner. In some examples, the coordinating AP 102-c may use broadcast IDs (such as b-C-rTWT IDs) to refer to membership groups associated with a coordination service period schedule (such as a b-C-rTWT service period schedule) and the associated one or more channel access parameters. Further, from the perspective of a coordinating AP 102-c, some broadcast IDs may be reserved for broadcast memberships where the coordinated AP 102-d is a participants opposed to membership groups solely containing STAs associated with the coordinating AP 102-c (such as the STA 104-c and the STA 104-d). Moreover, from the coordinated AP 102-d perspective, some broadcast IDs may be reserved for broadcast memberships orchestrated by the coordinating AP 102-c to propagate the coordination schedule as described elsewhere herein, such as with reference to FIG. 5B. Further, after the coordinating AP 102-c and the coordinated AP 102-d negotiate the coordination and the coordinating AP 102-c announces a C-rTWT service period schedule, the coordinated AP 102-d may terminate a transmission opportunity such that transmissions from the coordinated AP 102-d refrain from exceeding the C-rTWT service period boundary. Additionally, or alternatively, the coordinated AP 102-d may propagate the C-rTWT protection. For example, the coordinated AP 102-d may setup an EHT rTWT with the clients of the coordinated AP 102-d such that the C-rTWT service periods of the coordinating AP 102-c are protected.

Therefore, the techniques of the present disclosure may describe mechanisms that enable APs 102 operating on a same channel to be capable of coordinating respective rTWT schedules (such as via negotiation of schedules between APs 102 and advertisement of schedules), to ensure that a respective AP 102 can extend the protection of the rTWT schedule of another AP 102, or both. Further, in accordance with the techniques of the present disclosure, if an AP 102 extends the protection of an rTWT schedule for another AP 102, the AP 102 may ensure that a transmission opportunity is over before a start time of the corresponding OBSS rTWT service periods. Additionally, or alternatively, the AP 102 may advertise in the beacon frame that transmits the OBSS rTWT schedule one or more baseline rTWT rules such that STAs 104 associated with the AP 102 that are supporting rTWT follow the one or more baseline rTWT rules for the OBSS rTWT schedule.

Similar to the individually addressed management frame exchange coordination described with reference to FIG. 4A, the one or more second wireless devices 404 may negotiate the coordination and respond to the one or more first messages 408 from the coordinating AP 102-a, or vice versa when the one or more second wireless devices 404 request to be a part of a coordination. For example, the one or more second wireless devices 404 may transmit, via a second individually addressed management frame, an indication of an acceptance of a C-rTWT schedule indicated via a first individually addressed management frame from the first wireless device 402. By way of further example, for unsolicited coordination agreements, the coordinated AP 102-d may create a broadcast membership agreement and the coordinating AP 102-c may accept the membership agreement establishment. Further, the coordinating AP 102-c may transmit the coordination schedule (such as the indication of the one or more service periods) and the associated one or more channel access parameters via the beacon frame after the agreement is created via the acceptance message. Therefore, the coordinating AP 102-c may transmit a broadcast coordination information element to the coordinated AP 102-d that carries the broadcast coordination membership ID of the established agreement.

In some implementations, the coordinating AP 102-c may be capable of terminating an existing coordination with a coordinated AP 102-d or terminating a membership agreement with a coordinated AP 102-d (removing the coordinated AP 102-d from a broadcast membership group). In some examples, if the coordinating AP 102-c and the coordinated AP 102-d are within a same ESS in a proprietary or managed deployment, the APs 102 may be capable of broadcasting the coordination without any negotiations. For example, after the coordinating AP 102-c transmits a beacon to transmit the one or more first messages 408 to the STAs 104 associated with the coordinating AP 102-c (such as the STA 104-c and the STA 104-d), the coordinated AP 102-d and all other APs 102 of the same proprietary deployment may be configured to respect the coordination indicated via the beacon of the coordinating AP 102-c. The other APs 102 may be capable of receiving the coordination indications based on being part of the same ESS as the coordinating AP 102-c, the configuration of a respective AP 102, the capability of a respective AP 102 that is signaled previously, or any combination thereof.

Further, in a specified coordination element (such as a TWT element), a broadcast coordination element may include N parameter sets for N corresponding coordination schedules. For example, the coordination elements may include a respective parameter set (such as a respective requested parameter set) associated with each of the N coordination schedules (such as TWT schedules, which may be C-rTWT schedules). In some examples, the coordination element may include a single bit (such as a reserved bit) that can be used to signal that a coordination parameter set is used for service period coordination. Therefore, the coordinated AP 102-d that receives the beacon from the coordinating AP 102-c may be capable of parsing the coordination element and finding one or more coordination parameter sets with a flag set to a first value (such as 1). Moreover, the single-bit flag may be used to mark a service period coordination parameter set in a coordination element (the coordination element may include N single-bit flags for respective ones of the N coordination parameter sets) so that an AP 102 parsing the beacon is capable of interpreting a coordination schedule requested by an AP 102 that transmitted the coordination element. Additionally, or alternatively, the beacon may include both a coordination element and a coordination parameter set extension (such as a TWT parameter set extension), where the coordination parameter set extension carries a coordination ID (such as a TWT ID) of a pair to associate with the corresponding coordination parameter set. Further, the coordination ID may be a group-membership ID.

In some examples, the beacon from the coordinating AP 102-c may include a set of EDCA parameters for the STAs 104 associated with the coordinating AP 102-c (such as the STA 104-c and the STA 104-d) to use in the BSS. The beacon may further include a coordination element (such as a TWT element) indicating one or more channel access parameters for a respective coordination ID (such as a TWT parameter set for a TWT ID K). Additionally, or alternatively, the beacon also may include a coordination element extension (such as a TWT element extension) that indicates a coordination parameter set extension for the respective coordination ID (such as a TWT parameter set extension for the TWT ID K). Therefore, the STAs 104 associated with the coordinating AP 102-c may use the indicated one or more channel access parameters during the indicated one or more service periods based on the coordination ID indicated in the beacon of the coordinating AP 102-c. Moreover, the coordinated AP 102-d also may use the indicated one or more channel access parameters during the indicated one or more service periods based on the coordination ID indicated in the beacon of the coordinating AP 102-c. In some examples, the beacon from the coordinating AP 102-c also may include an indication of additional EDCA parameters via an additional EDCA parameter set for the coordinated AP 102-d to apply during the indicated one or more service periods. Therefore, the coordinating AP 102-c may include a first EDCA parameter element within the beacon to indicate the EDCA parameters for the STAs 104 associated with the coordinating AP 102-c to apply during the one or more service periods and a second EDCA parameter element to indicate the EDCA parameters for the coordinated AP 102-d to apply during the one or more service periods. Additionally, or alternatively, the coordinated AP 102-d may further transmit or broadcast the additional EDCA parameters and the indication of the one or more service periods to other APs 102, STAs 104 associated with the coordinated AP 102-d, or both.

In some examples, the schedules for the one or more service periods (such as the C-rTWT schedules) may be explicitly or implicitly shared between APs 102 (such as between the coordinating AP 102-c and the coordinated AP 102-d). An explicit indication of the C-rTWT schedules may be based on agreements being established via negotiations between the coordinating AP 102-c and the coordinated AP 102-d. An implicit indication may be based on a lack of agreements being established such that schedules for coordination can be marked such that capable APs 102 receiving the schedules (such as the coordinated AP 102-d) can provide enhanced medium access protection to the AP 102 that is broadcasting the schedule (such as the coordinating AP 102-c). Further, in some cases, the coordinating AP 102-c may use a coordination element (such as a TWT element as defined in one or both of the IEEE 802.11be and 802.11bn standard amendments) to provide rTWT schedules to the coordinated AP 102-d. In some examples, the TWT element may be used for the coordinating AP 102-c to schedule announcements within management frames (such as beacons). However, the coordinating AP 102-c may be expected to indicate or “mark” which schedules of a set of schedules the coordinating AP 102-c is requesting enhanced medium access protection from other APs 102. That is, the coordinating AP 102-c may be expected to indicate which schedules of a set of schedules are C-rTWT schedules.

The techniques of the present disclosure may describe the coordinating AP 102-c indicating one or more schedules (such as a single schedule or a set of schedules) as C-rTWT schedules, providing an indication of an action type for a respective schedule, providing a schedule or schedule modification for negotiations, or any combination thereof. For example, the coordinating AP 102-c may provide or indicate such information within a coordination information extension element (such as a TWT information extension element) that includes a control field for indicating a presence of additional octets at the end of the coordination element. In some examples, the coordinating AP 102-c may indicate via one or more elements (such as TWT information extension elements as defined in one or both of the IEEE 802.11be and 802.11bn standard amendments) in frame (such as the one or more first messages 408) that a schedule (such as a broadcast-TWT (b-TWT) schedule) is a C-rTWT schedule. In some examples, a b-TWT schedule may be an rTWT schedule or a C-rTWT schedule based on one or more parameters of the schedule or a configuration of the schedule. Further, such information may be included within the one or more first message 408 or may be within other messages. Thus, in accordance with the techniques of the present disclosure, to indicate either a respective b-TWT schedule is a rTWT schedule or a C-rTWT schedule, the coordinating AP 102-c may provide an indication within the one or more first messages 408. In some cases, the frame may be a broadcast frame (such as a beacon) and may also carry the coordination elements or TWT elements that indicate the information on one or more schedules. In another case, the frame may be an individually addressed management frame (such as a management frame for negotiating a C-rTWT membership). Further, in some examples, the individually addressed management frame may carry the TWT elements indicating the schedules (such as C-rTWT schedules) or the elements with the details or information of the schedules may be retrieved from another frame or message (such as from a beacon).

Moreover, in some examples, the coordinating AP 102-c may use a single element (such as TWT information extension element as defined in one or both of the IEEE 802.11be and 802.11bn standard amendments) that indicates which schedules (such as b-TWT schedules that are within the same frame or a different frame) are C-rTWT schedules. Further, the coordinating AP 102-c may request enhanced medium protection of the schedules that are C-rTWT schedules from other APs 102 (such as the coordinated AP 102-d). In some cases, the indication may be within a subfield (such as a C-rTWT Bitmap field) of a field (such as a b-TWT information field) of an element (such as a TWT information extension element as defined in one or both of the IEEE 802.11be and 802.11bn standard amendments) and the indication may be within a bitmap. For example, the coordinating AP 102-c may indicate, via a first bit (such as a C-rTWT Bitmap Present bit) of a control element of a first message 408 that a bitmap field (such as a C-rTWT bitmap field) is present within the respective first message 408. In some cases, the bitmap may include a quantity of bits such that each bit may represent a respective schedule, and a value of a bit may indicate whether a respective schedule is a C-rTWT schedule. For example, if a bit of the bitmap representing a respective schedule has a value of 0, the respective schedule may be a b-TWT schedule, and if the bit has a value of 1, the respective schedule may be a C-rTWT schedule, or vice versa. In some other examples, the coordinating AP 102-c may use a single element (such as a TWT information extension element) for each b-TWT element to indicate if a b-TWT schedule, that is carried within the same first message 408 or another frame or message, is a C-rTWT schedule. For example, the coordinating AP 102-c may transmit the indication via a subfield (such as a C-rTWT requested single bit field) of a field (such as a b-TWT information field) of the element (such as the TWT information extension element as defined in one or both of the IEEE 802.11be and 802.11bn standard amendments). Thus, the coordinating AP 102-c may transmit an indication that a b-TWT schedule is a C-rTWT schedule per b-TWT element or via a bitmap to indicate one or more schedule indications.

Further, in some examples, during negotiations APs 102 may assume that a schedule may be provided either explicitly or implicitly. For example, the coordinating AP 102-c may explicitly or implicitly indicate respective schedules within frames for AP 102 coordination frames (such as request, response, and notify frames for master-AP 102 (M-AP) coordination). Further, a TWT information extension element may be paired with one or more TWT elements to report explicit schedules and indicate or mark them as being for C-rTWT. In some cases, rather than directly indicating one or more TWT elements, the coordinating AP 102-c may indicate the full information for a respective schedule directly within the TWT information extension element. Additionally, or alternatively, in accordance with the techniques of the present disclosure, the coordinating AP 102-c may also use a field of an element (such as a TWT information extension element as defined in one or both of the IEEE 802.11be and 802.11bn standard amendments) to indicate an operation to be performed on a schedule. In some cases, the coordinating AP 102-c may transmit the indication via a field of the element (such as an operation type field of a TWT information extension element). For example, within a control field of the element, the coordinating AP 102-c may include an additional bit to indicate whether an operation type field is present. In some cases, if the bit is equal to 0, the bit of the control field may indicate that an operation type field is absent and if the bit is equal to 1, the bit of the control field may indicate that an operation type field is present. In another example, the coordinating AP 102-c may transmit the indication within a subfield of a field within the element (such as an operation type field indicated via the B-TWT information field of the TWT information extension element as defined in one or both of the IEEE 802.11be and 802.11bn standard amendments). Moreover, within such operation type field, the AP 102-c may indicate that a respective schedule or set of schedules are associated with acceptance operations, rejection operations, modification operations, or any other type of operation that can be performed in accordance with a C-rTWT schedule.

In some examples, the coordinating AP 102-c may also transmit an indication of a TWT parameters set via a field of an element (such as a TWT information extension element as defined in one or both of the IEEE 802.11be and 802.11bn standard amendments). In some cases, the coordinating AP 102-c may transmit an indication of one or more TWT parameters sets. For example, the AP 102-c may include an additional bit of a control field of the TWT information extension element to indicate whether a TWT parameters set field is present and if present the TWT parameters set field may include one or more TWT parameters sets. In some other cases, the AP 102-c may transmit or report a TWT element with a single TWT parameters set. For example, the AP 102-c may include an additional bit within the control field of the TWT information extension element indicating whether a TWT element field is present and if so the TWT element field may indicate a respective TWT element. Moreover, such TWT parameters set or TWT element may indicate the parameters of a C-rTWT schedule for the AP 102-c.

In some examples, after receiving such information via the one or more first messages 408 (such as a first individually addressed management frame), the coordinated AP 102-d may forward the information about the C-rTWT schedules (such as the respective parameter sets of the C-rTWT schedules indicated via the first individually addressed management frame) and other information to other APs 102 and STAs 104 associated with the coordinated AP 102-d to further ensure that the coordinating AP 102-c is capable of transmitting latency-sensitive data within a respective C-rTWT schedule. Further descriptions of the coordinated AP 102-d transmitting such information to other APs 102 and STAs 104 associated with the coordinated AP 102-d may be described elsewhere herein, such as with reference to FIGS. 5A and 5B.

FIG. 5A shows an example of a signaling diagram 500 that supports access point transmission service period coordination. The signaling diagram 500 may implement or be implemented to realize one or more aspects of the wireless communication network 100. For example, the signaling diagram 500 illustrates communications between one or more APs 102 (such as between an AP 102-e and an AP 102-f) as illustrated by and described with reference to FIG. 1 and communications between the APs 102 (such as the AP 102-f) and one or more STAs (such as a STA 104-e and a STA 104-f) as illustrated by and described with reference to FIG. 1. In some implementations, the AP 102-e may be referred to as a first wireless device, the AP 102-f may be referred to as a second wireless device of one or more second wireless devices, and the STA 104-c and the STA 104-d may be referred to as one or more third wireless devices. Further, the first wireless device may communicate with the one or more second wireless devices via one or more communication links 508 and the one or more second wireless devices may communicate with the one or more third wireless device via the one or more communication links 508 which may be examples of a communication link 106 as illustrated by and described with reference to FIG. 1.

In some implementations, as illustrated and described with reference to FIG. 4A, the AP 102-e may be referred to as a coordinating AP 102 and may transmit one or more first messages 510 (such as one or more first messages 510-a that may be or may include a first individually addressed management frame) to the AP 102-f, which may be referred to as a coordinated AP 102, via a communication link 508-a. In some other implementations, the AP 102-f may be the coordinating AP 102 and the AP 102-e may be the coordinated AP 102. Further, the coordinating AP 102-e may transmit the one or more first messages 510 to indicate one or more service periods for the coordinating AP 102-e to transmit latency-sensitive traffic and to indicate one or more channel access parameters for the coordinated AP 102-f to apply during the one or more service periods. As part of the coordination between the coordinating AP 102-e and the coordinated AP 102-f, the coordinating AP 102-e may also request that the STAs 104 associated with the coordinating AP 102-e, the coordinated AP 102-f, the STAs 104 associated with the coordinated AP 102-f, or any combination thereof refrain from transmitting communications during the one or more service periods in accordance with the indicated one or more channel access parameters. To indicate the one or more service periods and the one or more channel access parameters to the STAs 104 associated with the coordinated AP 102-f (such as the STA 104-e and the STA 104-f), the coordinated AP 102-f may propagate the one or more first messages 510 to the STA 104-e and the STA 104-f. Therefore, the coordinated AP 102-f may propagate the coordination schedule indicated by the coordinating AP 102-e to the STAs 104 associated with the coordinated AP 102-f.

For example, the coordinated AP 102-f may transmit one or more first messages 510-b to the STA 104-e via a communication link 508-b and one or more first messages 510-c to the STA 104-f via a communication link 508-c. Thus, the coordinating AP 102-e may ensure that the STAs 104 associated with the coordinating AP 102-e, the coordinated AP 102-f, and the STAs 104 associated with the coordinated AP 102-f refrain from transmitting communications during the indicated one or more service periods. For example, since the coordinating AP 102-e may indicate a coordination scheme between the coordinating AP 102-e and the coordinated AP 102-f, the coordinated AP 102-f may transmit an indication of the coordination scheme, and a respective parameter set associated with a C-rTWT schedule that corresponds to the coordination scheme to the STA 104-e and the STA 104-f. Moreover, the coordinated AP 102-f may also transmit an indication of an acceptance of a C-rTWT schedule to the coordinating AP 102-e and then transmit the indication of the C-rTWT schedule and the respective parameter set of the accepted C-rTWT schedule to the STA 104-e and the STA 104-f to limit interruptions during the accepted C-rTWT schedule. Therefore, the coordinating AP 102-e may be capable of communicating one or more messages during one or more service periods of the at least one C-rTWT schedule that is accepted by the coordinated AP 102-f to ensure efficient and reliable communications for latency-sensitive traffic. In some examples, the coordinating AP 102-e and the coordinated AP 102-f may broadcast the indications via beacon frames, which may be further described elsewhere herein, such as with reference to FIG. 5B.

FIG. 5B shows an example of a signaling diagram 501 that supports access point transmission service period coordination. The signaling diagram 501 may implement or be implemented to realize one or more aspects of the wireless communication network 100. For example, the signaling diagram 501 illustrates communications between one or more APs 102 (such as between an AP 102-g and an AP 102-h) as illustrated by and described with reference to FIG. 1 and communications between the APs 102 (such as the AP 102-h) and one or more STAs (such as a STA 104-g and a STA 104-h) as illustrated by and described with reference to FIG. 1. In some implementations, the AP 102-g may be referred to as a first wireless device, the AP 102-h may be referred to as a second wireless device of one or more second wireless devices, and the STA 104-g and the STA 104-h may be referred to as one or more third wireless devices. Further, the first wireless device may communicate with the one or more second wireless devices via one or more beams 512 of the AP 102-g and the one or more second wireless devices may communicate with the one or more third wireless device via one or more beams 514 of the AP 102-h.

In some implementations, as illustrated and described with reference to FIG. 4B, the AP 102-g may be referred to as a coordinating AP 102 and may transmit one or more first messages 510 to the AP 102-h which may be referred to as a coordinated AP 102. In some other implementations, the AP 102-h may be the coordinating AP 102 and the AP 102-g may be the coordinated AP 102. In some examples, as illustrated herein, in order to reduce the signaling overhead of transmitting the one or more first messages 510, the coordinating the AP 102-g may transmit the one or more first messages 510 to the coordinated AP 102-h via a first group-addressed message via one or more beams 512 at the coordinating AP 102-g. The first group addressed message may indicate the one or more service periods associated with the coordinating AP 102-g and the one or more channel parameters for the coordinated AP 102-h to apply during the one or more service periods associated with the coordinating AP 102-g. Further, as described with reference to FIG. 5A, the coordinated AP 102-h may propagate the one or more first messages 510 to the STAs 104 associated with the coordinated AP 102-h (such as the STA 104-g and the STA 104-h) via the one or more beams 514 at the coordinated AP 102-h. Therefore, the coordinated AP 102-h may transmit the one or more first messages 510 indicated by the coordinating AP 102-g to the STAs 104 (such as the STA 104-g and the STA 104-h) associated with the coordinated AP 102-h via the one or more beams 514 of the coordinated AP 102-h.

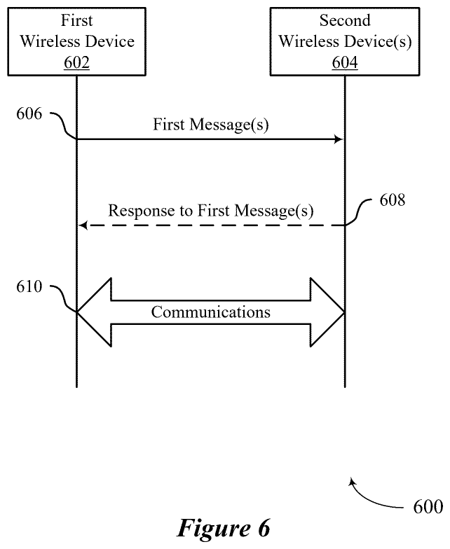

In some examples, the one or more first messages 510 may be associated with a broadcast coordination ID, where from the coordinated AP 102-h perspective, some broadcast coordination IDs can be reserved for broadcast coordination memberships orchestrated by the coordinating AP 102-g to propagate the coordinate schedule of the coordinating AP 102-g to the STAs 104 associated with the coordinated AP 102-h. Further, the coordinated AP 102-h may use a bit flag to indicate a respective coordination parameter set, as described with reference to FIG. 4A, to propagate the respective coordination parameter set to the STAs 104 associated with the coordinated AP 102-h. Additionally, or alternatively, the beacon frame from the coordinating AP 102-g may include a first set of EDCA parameters for the STAs 104 associated with the coordinating AP 102-g and a second set of EDCA parameters for the coordinated AP 102-h and the STAs 104 associated with the coordinated AP 102-h. Therefore, the beacon from the coordinating AP 102-g may further enhance the capability of the coordinating AP 102-g to transmit and serve latency-sensitive traffic during one or more coordinated service periods by having coordinated AP 102-h and the STAs 104 associated with the coordinated AP 102-h (such as the STA 104-g and the STA 104-h) refrain from transmitting communications during the one or more service periods in accordance with the indicated one or more channel access parameters. Further descriptions of the techniques of the present disclosure that enhance the ability of an AP 102 to serve latency-sensitive traffic may be described elsewhere herein, such as with reference to FIG. 6.

FIG. 6 shows an example of a process flow 600 that supports access point transmission service period coordination. In some implementations, the process flow 600 may implement or be implemented by the wireless communication network 100. For example, the process flow 600 may illustrate communication between a first wireless device 602 and one or more second wireless devices 604, which may be examples of APs 102, STAs 104, or both, as described herein with reference to FIG. 1.

In the following description of the process flow 600, the operations between the first wireless device 602 and the one or more second wireless devices 604 may be performed in different orders or at different times. Some operations also may be left out of the process flow 600, or other operations may be added. Although the first wireless device 602 and the one or more second wireless devices 604 are shown performing the operations of the process flow 600, some aspects of some operations also may be performed by one or more other wireless devices.

At 606, the first wireless device 602 (such as a first AP 102) may transmit, to the one or more second wireless devices 604 (such as a second AP 102), one or more first messages indicating one or more service periods associated with the first wireless device 602. In some implementations, the one or more first messages may be or may include a first individually addressed management frame. In such implementations, the first individually addressed management frame may include an indication of at least one requested coordination scheme between the first AP 102 and the second AP 102 and the at least one requested coordination scheme may be associated with one or more C-rTWT schedules. In some implementations, the at least one requested coordination scheme may be from a set of coordination schemes that includes a C-rTWT scheme, a C-SR scheme, a C-TDMA scheme, or any combination thereof. Further, the first individually addressed management frame may include an element that indicates a respective parameter set associated with each C-rTWT schedule of the one or more C-rTWT schedules. In some implementations, the element may include a coordination element, a TWT element, or both.

In some implementations, the one or more first messages (such as the first individually addressed management frame) may indicate the one or more service periods associated with the first wireless device 602 and one or more channel access parameters for the one or more second wireless devices 604 to apply during the one or more service periods associated with the first wireless device 602. In some other cases, the one or more first messages may refrain from indicating the one or more channel access parameters for the one or more second wireless devices 604 to apply during the one or more service periods associated with the first wireless device 602. In some examples, prior to transmitting the one or more first messages, the first wireless device 602 may transmit, to the one or more second wireless devices 604, an indication of a first public key that is associated with the first wireless device 602. Further, the first wireless device 602 may receive, from the one or more second wireless devices 604, an indication of one or more public keys, that includes a second public key, associated with the one or more second wireless devices 604. Therefore, the first wireless device 602 may obtain a common key in accordance with transmitting the indication of the first public key associated with the first wireless device 602 and receiving the indication of the one or more public keys that includes the second public key and is associated with the one or more second wireless devices 604. Further, the one or more first messages (such as the first individually addressed management frame) may be transmitted based on the common key being obtained. In some other implementations, prior to transmitting the one or more first messages, the first wireless device 602 may transmit, to the one or more second wireless devices 604, and ID associated with the first wireless device 602, one or more capabilities indicating support for service period coordination, or a combination thereof. Therefore, the first wireless device 602 may transmit the one or more first messages (the first individually addressed management frame) in accordance with the one or more capabilities.

In some examples, the first wireless device 602 may transmit, to the one or more second wireless devices 604, the one or more first messages (the first individually addressed management frame) requesting the one or more second wireless devices 604 to refrain from transmitting communications during the one or more service periods or the one or more C-rTWT schedules, at start of the one or more service periods or the one or more C-rTWT schedules, or a combination thereof. In some other examples, the first wireless device 602 may transmit, to the one or more second wireless devices 604, an indication that the one or more second wireless devices 604 will refrain from transmitting communications during the one or more service periods.

Additionally, or alternatively, the first wireless device 602 may transmit, to the one or more second wireless devices 604, a first group addressed message that indicates the one or more service periods associated with the first wireless device 602 and the one or more channel access parameters for the one or more second wireless devices 604 to apply during the one or more service periods associated with the first wireless device 602. Moreover, the first wireless device 602 may be an AP 102 for a subset of the one or more second wireless devices 604. Further, in some implementations, each respective first message of the one or more first messages may include a first bit. In some examples, the first bit may indicate a presence of the one or more channel access parameters, a respective parameter set associated with each C-rTWT schedule of one or more C-rTWT schedules, or a combination thereof for the one or more second wireless devices 604 to apply during the one or more service periods within the respective first message. In some other examples, the first bit may indicate a presence of an extension frame within the respective first message. Additionally, or alternatively, the first bit may indicate the presence of additional information for the indicated one or more service periods associated with the first wireless device 602.

In some implementations, the one or more first messages also may be associated with the one or more channel access parameters with an ID that is associated with the one or more service periods. Further the ID that is associated with the one or more service periods may be a wireless device ID indicating a wireless device that is associated with the one or more service periods, an ID of a coordination scheme associated with the one or more service periods, or a combination thereof. Moreover, in some examples, the one or more channel access parameters indicated via the one or more first messages may include a first set of channel access parameters for a first subset of wireless devices of the one or more second wireless devices 604 that is associated with the first wireless device 602 and a second set of channel access parameters for a second subset of wireless devices of the one or more second wireless devices 604 that is unassociated with the first wireless device 602. At 608, the one or more second wireless devices 604 may message (such as a third message) indicating a response to a first message of the one or more first messages prior to the first wireless device 602 communicating one or more second messages. In some examples, the response to the first message may indicate an acceptance to refrain from transmitting the communications during the one or more service periods in accordance with of the one or more channel access parameters, in the case where the first message indicates the one or more channel access parameters. For example, the one or more second wireless devices 604 may transmit, to the first wireless device 602, a second individually addressed management frame that includes an indication of an acceptance of at least one C-rTWT schedule of the one or more C-rTWT schedules indicated via the one or more first messages (the first individually addressed management frame). In some implementations, the second individually addressed management frame may also include at least one flag that indicates the at least one C-rTWT schedule of the one or more C-rTWT schedules.

In some other examples, the response to the first message may indicate a proposed modification of the request to refrain from transmitting the communications during the one or more service periods in accordance with the one or more channel access parameters, in the case where the first message indicates the one or more channel access parameters. Additionally, or alternatively, the response to the first message may indicate a rejection to refrain from transmitting the communications during the one or more service periods in accordance with the one or more channel access parameters, in the case where the first message indicates the one or more channel access parameters. Therefore, at 610, the first wireless device 602 may communicate the one or more second messages during the one or more service periods based on the coordination. For example, the first wireless device 602 may communicate the one or more second messages based on receiving the third message from the one or more second wireless devices 604 indicating a response to the one or more first messages.

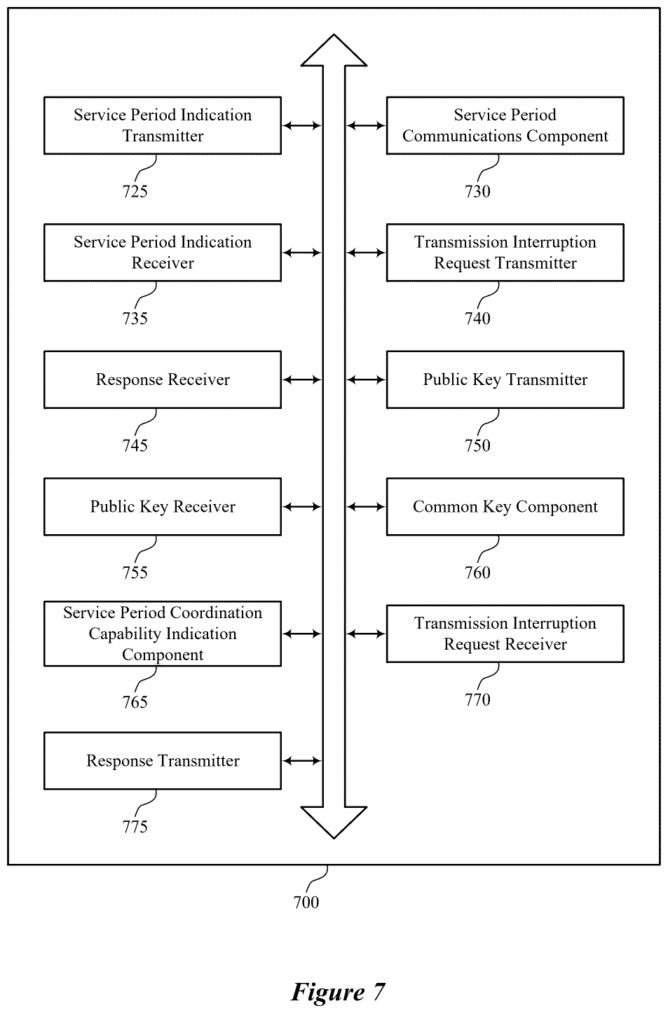

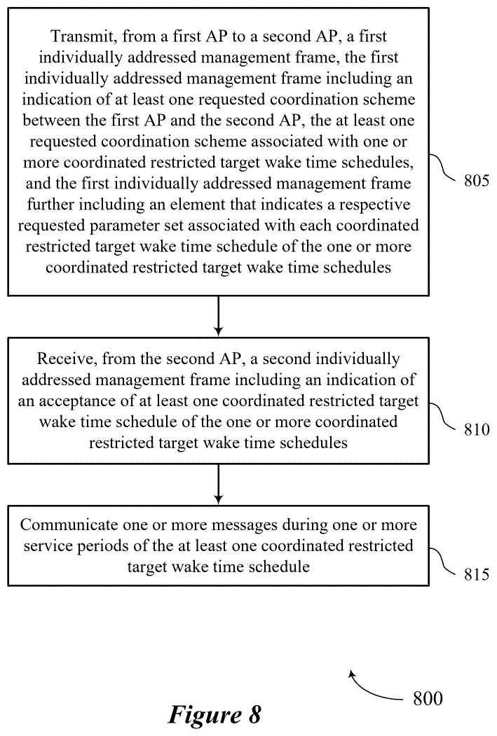

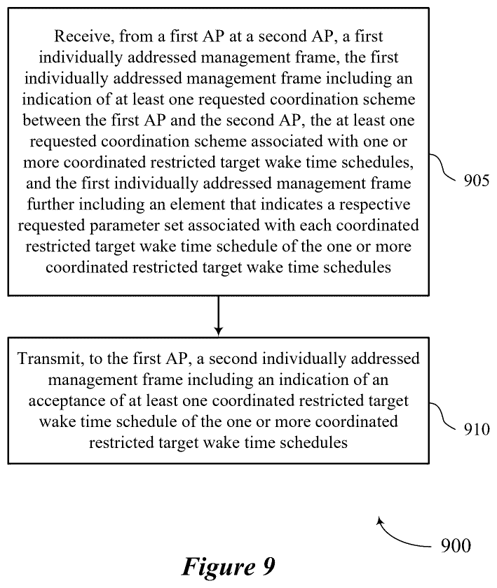

FIG. 7 shows a block diagram of an example wireless communication device 700 that supports access point transmission service period coordination. In some examples, the wireless communication device 700 is configured to perform the processes 800 and 900 described with reference to FIGS. 8 and 9, respectively. The wireless communication device 700 may include one or more chips, SoCs, chipsets, packages, components or devices that individually or collectively constitute or include a processing system. The processing system may interface with other components of the wireless communication device 700, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 700 may transmit the information output from the chip. In such an example, the second interface may refer to an interface between the processing system of the chip and a reception component, such that the wireless communication device 700 may receive information that is then passed to the processing system. In some such examples, the first interface also may obtain information, such as from the transmission component, and the second interface also may output information, such as to the reception component.

The processing system of the wireless communication device 700 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 700 can be configurable or configured for use in an AP, such as the AP 102 described with reference to FIG. 1. In some other examples, the wireless communication device 700 can be an AP that includes such a processing system and other components including multiple antennas. The wireless communication device 700 is capable of transmitting and receiving wireless communications in the form of, for example, wireless packets. For example, the wireless communication device 700 can be configurable or configured to transmit and receive packets in the form of physical layer PPDUs and MPDUs conforming to one or more of the IEEE 802.11 family of wireless communication protocol standards. In some other examples, the wireless communication device 700 can be configurable or configured to transmit and receive signals and communications conforming to one or more 3GPP specifications including those for 5G NR or 6G. In some examples, the wireless communication device 700 also includes or can be coupled with one or more application processors which may be further coupled with one or more other memories. In some examples, the wireless communication device 700 further includes at least one external network interface coupled with the processing system that enables communication with a core network or backhaul network that enables the wireless communication device 700 to gain access to external networks including the Internet.

The wireless communication device 700 includes a service period indication transmitter 725, a service period communications component 730, a service period indication receiver 735, a transmission interruption request transmitter 740, a response receiver 745, a public key transmitter 750, a public key receiver 755, a common key component 760, a service period coordination capability indication component 765, a transmission interruption request receiver 770, and a response transmitter 775. Portions of one or more of the service period indication transmitter 725, the service period communications component 730, the service period indication receiver 735, the transmission interruption request transmitter 740, the response receiver 745, the public key transmitter 750, the public key receiver 755, the common key component 760, the service period coordination capability indication component 765, the transmission interruption request receiver 770, and the response transmitter 775 may be implemented at least in part in hardware or firmware. For example, one or more of the service period indication transmitter 725, the service period communications component 730, the service period indication receiver 735, the transmission interruption request transmitter 740, the response receiver 745, the public key transmitter 750, the public key receiver 755, the common key component 760, the service period coordination capability indication component 765, the transmission interruption request receiver 770, and the response transmitter 775 may be implemented at least in part by at least a processor or a modem. In some examples, portions of one or more of the service period indication transmitter 725, the service period communications component 730, the service period indication receiver 735, the transmission interruption request transmitter 740, the response receiver 745, the public key transmitter 750, the public key receiver 755, the common key component 760, the service period coordination capability indication component 765, the transmission interruption request receiver 770, and the response transmitter 775 may be implemented at least in part by a processor and software in the form of processor-executable code stored in memory.

The wireless communication device 700 may support wireless communications in accordance with examples as disclosed herein. The service period indication transmitter 725 is configurable or configured to transmit, to one or more second wireless devices, one or more first messages indicating one or more service periods associated with the first wireless device and one or more channel access parameters for the one or more second wireless devices to apply during the one or more service periods associated with the first wireless device. The service period communications component 730 is configurable or configured to communicate, during the one or more service periods, one or more second messages.

In some examples, to support transmitting the one or more first messages, the transmission interruption request transmitter 740 is configurable or configured to transmit, to the one or more second wireless devices, the one or more first messages indicating a request that the one or more second wireless devices refrain from transmitting communications during the one or more service periods, at the start of the one or more service periods, or a combination thereof. In some examples, to support transmitting the one or more first messages, the response receiver 745 is configurable or configured to receive, from the one or more second wireless devices, a third message indicating a response to a first message of the one or more first messages, where the third message is received prior to communicating the one or more second messages.

In some examples, the response to the first message indicates an acceptance to refrain from transmitting the communications during the one or more service periods in accordance with the one or more channel access parameters, a proposed modification of the request to refrain from transmitting the communications during the one or more service periods in accordance with the one or more channel access parameters, a rejection to refrain from transmitting the communications during the one or more service periods in accordance with the one or more channel access parameters, or any combination thereof.

In some examples, to support transmitting the one or more first messages, the service period indication transmitter 725 is configurable or configured to transmit, to the one or more second wireless devices, an indication that the one or more second wireless devices will refrain from transmitting communications during the one or more service periods.

In some examples, to support transmitting the one or more first messages, the service period indication transmitter 725 is configurable or configured to transmit, to the one or more second wireless devices, a first group addressed message that indicates the one or more service periods associated with the first wireless device and the one or more channel access parameters for the one or more second wireless devices during the one or more service periods associated with the first wireless device, where the first wireless device is an access point for a subset of the one or more second wireless devices.

In some examples, each respective first message of the one or more first messages includes a first bit that indicates a presence of the one or more channel access parameters for the one or more second wireless devices to apply during the one or more service periods within the respective first message, a presence of an extension frame within the respective first message, a presence of additional information for the indicated one or more service periods associated with the first wireless device, or a combination thereof.

In some examples, to support transmitting the one or more first messages, the service period indication transmitter 725 is configurable or configured to transmit, via one or more elements of each respective first message of the one or more first messages, an indication of one or more schedules of a set of schedules being associated with the one or more service periods.

In some examples, to support transmitting the indication of the one or more schedules, the service period indication transmitter 725 is configurable or configured to transmit, via each respective first message, a first bit within a control element indicating a presence of a bitmap, wherein the respective first message includes the bitmap based on the first bit within the control element.

In some examples, the bitmap includes a set of bits for the set of schedules and each respective bit of the set of bits indicates whether a respective schedule is associated the one or more service periods.

In some examples, to support transmitting the indication of the one or more schedules, the service period indication transmitter 725 is configurable or configured to transmit, via each respective first message, one or more indications of the one or more schedules of the set of schedules that are associated with the one or more service periods via an information field within the one or more first messages, where each respective indication of the one or more indications is for a respective schedule of the one or more schedules.

In some examples, the one or more schedules of the set of schedules that are associated with the one or more service periods are C-rTWT schedules.

In some examples, to support transmitting the one or more first messages, the service period indication transmitter 725 is configurable or configured to transmit, via an element of each respective first message of the one or more first messages, an indication of an operation type for a respective schedule indicated via the one or more first messages.

In some examples, to support transmitting the indication of the operation type, the service period indication transmitter 725 is configurable or configured to transmit, via each respective first message, a first bit within a control element indicating a presence of an operation type field, the operation type field including the indication of operation type.

In some examples, to support transmitting the indication of the operation type, the service period indication transmitter 725 is configurable or configured to transmit, via each respective first message, the indication of the operation type within an information element.

In some examples, the operation type includes an acceptance operation, a rejection operation, a modification operation, or any combination thereof.

In some examples, to support transmitting the one or more first messages, the service period indication transmitter 725 is configurable or configured to transmit, via an element of each respective first message of the one or more first messages, an indication one or more sets of TWT parameters for one or more schedules associated with the one or more service periods.

In some examples, to support transmitting the one or more sets of TWT parameters, the service period indication transmitter 725 is configurable or configured to transmit, via each respective first message, a first bit within a control element indicating a presence of a field that indicates the one or more sets of TWT parameters.

In some examples, to support transmitting the one or more sets of TWT parameters, the service period indication transmitter 725 is configurable or configured to transmit, via each respective first message, a first bit within a control element indicating a presence of a field that indicates a respective set of TWT parameters of the one or more sets of TWT parameters for a respective schedule of the one or more schedules.

In some examples, the public key transmitter 750 is configurable or configured to transmit, to the one or more second wireless devices, an indication of a public key associated with the first wireless device. In some examples, the public key receiver 755 is configurable or configured to receive, from the one or more second wireless devices, an indication of one or more public keys associated with the one or more second wireless devices. In some examples, the common key component 760 is configurable or configured to obtain a common key in accordance with transmitting the indication of the public key associated with the first wireless device and receiving the indication of the one or more public keys associated with the one or more second wireless devices, where the one or more first messages are transmitted are associated at least in part with the common key.

In some examples, the one or more first messages associates the one or more channel access parameters with an identifier that is associated with the one or more service periods.

In some examples, the identifier that is associated with the one or more service periods is a wireless device identifier indicating one or more of: a third wireless device that is associated with the one or more service periods, an identifier of a coordination scheme associated with the one or more service periods, or a combination thereof.

In some examples, the one or more channel access parameters indicated via the one or more first messages includes a first set of channel access parameters for a first subset of wireless devices of the one or more second wireless devices that is associated with the first wireless device and a second set of channel access parameters for a second subset of wireless devices of the one or more second wireless devices that is unassociated with the first wireless device.

In some examples, the service period coordination capability indication component 765 is configurable or configured to transmit, to the one or more second wireless devices, an identifier associated with the first wireless device, one or more capability messages indicating support for service period coordination, or a combination thereof, where the one or more first messages are transmitted in accordance with the one or more capability messages.

Additionally, or alternatively, the wireless communication device 700 may support wireless communications in accordance with examples as disclosed herein. The service period indication receiver 735 is configurable or configured to receive, from a first wireless device, one or more first messages indicating one or more service periods associated with the first wireless device and one or more channel access parameters for the second wireless device to apply during the one or more service periods associated with the first wireless device. In some examples, the service period communications component 730 is configurable or configured to communicate, during the one or more service periods, in accordance with the one or more channel access parameters indicated via the one or more first messages.

In some examples, to support receiving the one or more first messages, the transmission interruption request receiver 770 is configurable or configured to receive, from the first wireless device, the one or more first messages indicating a request that the second wireless device refrains from transmitting communications during the one or more service periods, at a start of the one or more service periods, or a combination thereof. In some examples, to support receiving the one or more first messages, the response transmitter 775 is configurable or configured to transmit, to the first wireless device, a second message indicating a response to a first message of the one or more first messages.

In some examples, the response to the first message indicates an acceptance to refrain from transmitting the communications during the one or more service periods in accordance with the one or more channel access parameters, a proposed modification of the request to refrain from transmitting the communications during the one or more service periods in accordance with the one or more channel access parameters, a rejection to refrain from transmitting the communications during the one or more service periods in accordance with the one or more channel access parameters, or any combination thereof.

In some examples, to support receiving the one or more first messages, the service period indication receiver 735 is configurable or configured to receive, from the first wireless device, an indication to refrain from transmitting communications during the one or more service periods.

In some examples, to support receiving the one or more first messages, the service period indication receiver 735 is configurable or configured to receive, from the first wireless device, a first group addressed message that indicates the one or more service periods associated with the first wireless device and the one or more channel access parameters for the second wireless device during the one or more service periods associated with the first wireless device. In some examples, to support receiving the one or more first messages, the service period indication transmitter 725 is configurable or configured to transmit, to one or more third wireless devices, a second group addressed message that indicates the one or more service periods associated with the first wireless device and one or more second channel access parameters for the one or more third wireless devices during the one or more service periods associated with the first wireless device, the one or more second channel access parameters being in accordance with the one or more channel access parameters for the second wireless device, where the second wireless device is an access point for a subset of the one or more third wireless devices.

In some examples, each respective first message of the one or more first messages includes a first bit that indicates a presence of the one or more channel access parameters to apply during the one or more service periods within the respective first message, a presence of an extension frame within the respective first message, a presence of additional information for the indicated one or more service periods associated with the first wireless device, or a combination thereof.

In some examples, to support receiving the one or more first messages, the service period indication receiver 735 is configurable or configured to receive, via one or more elements of each respective first message of the one or more first messages, an indication of one or more schedules of a set of schedules being associated with the one or more service periods.

In some examples, to support receiving the indication of the one or more schedules, the service period indication receiver 735 is configurable or configured to receive, via each respective first message, a first bit within a control element indicating a presence of a bitmap, wherein the respective first message includes the bitmap based on the first bit within the control element.

In some examples, the bitmap includes a set of bits for the set of schedules and each respective bit of the set of bits indicates whether a respective schedule is associated the one or more service periods.

In some examples, to support receiving the indication of the one or more schedules, the service period indication receiver 735 is configurable or configured to receive, via each respective first message, one or more indications of the one or more schedules of the set of schedules that are associated with the one or more service periods via an information field within the one or more first messages, where each respective indication of the one or more indications is for a respective schedule of the one or more schedules.

In some examples, the one or more schedules of the set of schedules that are associated with the one or more service periods are C-rTWT schedules.

In some examples, to support receiving the one or more first messages, the service period indication receiver 735 is configurable or configured to receive, via an element of each respective first message of the one or more first messages, an indication of an operation type for a respective schedule indicated via the one or more first messages.

In some examples, to support receiving the indication of the operation type, the service period indication receiver 735 is configurable or configured to receive, via each respective first message, a first bit within a control element indicating a presence of an operation type field, the operation type field including the indication of operation type.

In some examples, to support receiving the indication of the operation type, the service period indication receiver 735 is configurable or configured to receive, via each respective first message, the indication of the operation type within an information element.

In some examples, the operation type includes an acceptance operation, a rejection operation, a modification operation, or any combination thereof.

In some examples, to support receiving the one or more first messages, the service period indication receiver 735 is configurable or configured to receive, via an element of each respective first message of the one or more first messages, an indication one or more sets of TWT parameters for one or more schedules associated with the one or more service periods.

In some examples, to support receiving the one or more sets of TWT parameters, the service period indication receiver 735 is configurable or configured to receive, via each respective first message, a first bit within a control element indicating a presence of a field that indicates the one or more sets of TWT parameters.

In some examples, to support receiving the one or more sets of TWT parameters, the service period indication receiver 735 is configurable or configured to receive, via each respective first message, a first bit within a control element indicating a presence of a field that indicates a respective set of TWT parameters of the one or more sets of TWT parameters for a respective schedule of the one or more schedules.

In some examples, the public key receiver 755 is configurable or configured to receive, from the first wireless device, an indication of a public key associated with the first wireless device. In some examples, the public key transmitter 750 is configurable or configured to transmit, to the first wireless device, an indication of a public key associated with the second wireless device. In some examples, the common key component 760 is configurable or configured to obtain a common key in accordance with receiving the indication of the public key associated with the second wireless device and transmitting the indication of the public key associated with the first wireless device, where the one or more first messages received are associated at least in part with the common key.

In some examples, the one or more first messages associates the one or more channel access parameters with an identifier that is associated with the one or more service periods.

In some examples, the identifier that is associated with the one or more service periods is a wireless device identifier indicating one or more of: a wireless device that is associated with the one or more service periods, an identifier of a coordination scheme associated with the one or more service periods, or a combination thereof.

In some examples, the one or more channel access parameters indicated in the one or more first messages includes a set of channel access parameters for the second wireless device and for one or more third wireless devices that are associated with the first wireless device.

In some examples, the service period coordination capability indication component 765 is configurable or configured to receive, from the first wireless device, an identifier associated with the second wireless device, one or more capability messages indicating support for service period coordination, or a combination thereof, where the one or more first messages are received in accordance with the one or more capability messages.

FIG. 8 shows a flowchart illustrating an example process 800 performable by or at an apparatus that supports considerations on C-rTWT framework. The operations of the process 800 may be implemented by an apparatus or its components as described herein. For example, the process 800 may be performed by a wireless communication device, such as the wireless communication device 700 described with reference to FIG. 7, operating as or within a wireless AP. In some examples, the process 800 may be performed by a wireless AP, such as one of the APs 102 described with reference to FIG. 1.

In some examples, in 805, the apparatus may transmit, from a first AP to a second AP, a first individually addressed management frame, the first individually addressed management frame including an indication of at least one requested coordination scheme between the first AP and the second AP, the at least one requested coordination scheme associated with one or more coordinated restricted target wake time schedules, and the first individually addressed management frame further including an element that indicates a respective requested parameter set associated with each coordinated restricted target wake time schedule of the one or more coordinated restricted target wake time schedules. The operations of 805 may be performed in accordance with examples as disclosed herein. In some implementations, aspects of the operations of 805 may be performed by a service period indication transmitter 725 as described with reference to FIG. 7.

In some examples, in 810, the apparatus may receive, from the second AP, a second individually addressed management frame including an indication of an acceptance of at least one coordinated restricted target wake time schedule of the one or more coordinated restricted target wake time schedules. The operations of 810 may be performed in accordance with examples as disclosed herein. In some implementations, aspects of the operations of 810 may be performed by a service period indication receiver 735 as described with reference to FIG. 7.

In some examples, in 815, the apparatus may communicate one or more messages during one or more service periods of the at least one coordinated restricted target wake time schedule. The operations of 815 may be performed in accordance with examples as disclosed herein. In some implementations, aspects of the operations of 815 may be performed by a service period communications component 730 as described with reference to FIG. 7.

FIG. 9 shows a flowchart illustrating an example process 900 performable by or at an apparatus that supports considerations on C-rTWT framework. The operations of the process 900 may be implemented by an apparatus or its components as described herein. For example, the process 900 may be performed by a wireless communication device, such as the wireless communication device 700 described with reference to FIG. 7, operating as or within a wireless AP. In some examples, the process 900 may be performed by a wireless AP, such as one of the APs 102 described with reference to FIG. 1.

In some examples, in 905, the apparatus may receive, from a first AP at a second AP, a first individually addressed management frame, the first individually addressed management frame including an indication of at least one requested coordination scheme between the first AP and the second AP, the at least one requested coordination scheme associated with one or more coordinated restricted target wake time schedules, and the first individually addressed management frame further including an element that indicates a respective requested parameter set associated with each coordinated restricted target wake time schedule of the one or more coordinated restricted target wake time schedules. The operations of 905 may be performed in accordance with examples as disclosed herein. In some implementations, aspects of the operations of 905 may be performed by a service period indication receiver 735 as described with reference to FIG. 7.

In some examples, in 910, the apparatus may transmit, to the first AP, a second individually addressed management frame including an indication of an acceptance of at least one coordinated restricted target wake time schedule of the one or more coordinated restricted target wake time schedules. The operations of 910 may be performed in accordance with examples as disclosed herein. In some implementations, aspects of the operations of 910 may be performed by a service period indication transmitter 725 as described with reference to FIG. 7.

Implementation examples are described in the following numbered clauses.

Clause 1: A method for wireless communication, comprising: transmitting, from a first wireless device to one or more second wireless devices, one or more first messages indicating one or more service periods associated with the first wireless device and one or more channel access parameters for the one or more second wireless devices to apply during the one or more service periods associated with the first wireless device; and communicating, during the one or more service periods, one or more second messages.

Clause 2: The method of clause 1, wherein transmitting the one or more first messages comprises: transmitting, to the one or more second wireless devices, the one or more first messages indicating a request that the one or more second wireless devices refrain from transmitting communications during the one or more service periods, at a start of the one or more service periods, or a combination thereof; and receiving, from the one or more second wireless devices, a third message indicating a response to a first message of the one or more first messages, wherein the third message is received prior to communicating the one or more second messages.

Clause 3: The method of clause 2, wherein the response to the first message indicates an acceptance to refrain from transmitting the communications during the one or more service periods in accordance with the one or more channel access parameters, a proposed modification of the request to refrain from transmitting the communications during the one or more service periods in accordance with the one or more channel access parameters, a rejection to refrain from transmitting the communications during the one or more service periods in accordance with the one or more channel access parameters, or any combination thereof.

Clause 4: The method of any of clauses 1 through 3, wherein transmitting the one or more first messages comprises: transmitting, to the one or more second wireless devices, an indication that the one or more second wireless devices will refrain from transmitting communications during the one or more service periods.

Clause 5: The method of any of clauses 1 through 4, wherein transmitting the one or more first messages comprises: transmitting, to the one or more second wireless devices, a first group addressed message that indicates the one or more service periods associated with the first wireless device and the one or more channel access parameters for the one or more second wireless devices during the one or more service periods associated with the first wireless device, wherein the first wireless device is an access point for a subset of the one or more second wireless devices.

Clause 6: The method of any of clauses 1 through 5, wherein each respective first message of the one or more first messages comprises a first bit that indicates a presence of the one or more channel access parameters for the one or more second wireless devices to apply during the one or more service periods within the respective first message, a presence of an extension frame within the respective first message, a presence of additional information for the indicated one or more service periods associated with the first wireless device, or a combination thereof.

Clause 7: The method of any of clauses 1 through 6, further comprising: transmitting, to the one or more second wireless devices, an indication of a public key associated with the first wireless device; receiving, from the one or more second wireless devices, an indication of one or more public keys associated with the one or more second wireless devices; and obtaining a common key in accordance with transmitting the indication of the public key associated with the first wireless device and receiving the indication of the one or more public keys associated with the one or more second wireless devices, wherein the one or more first messages are transmitted are associated at least in part with the common key.

Clause 8: The method of any of clauses 1 through 7, wherein the public key of the one or more second wireless device is associate with an ID of the one or more second wireless devices in accordance with receiving the public key from the one or more second wireless devices.

Clause 9: The method of any of clauses 1 through 8, wherein the one or more first messages associates the one or more channel access parameters with an ID that is associated with the one or more service periods.

Clause 10: The method of clause 9, wherein a third wireless device that is associated with the one or more service periods, an ID of a coordination scheme associated with the one or more service periods, or a combination thereof.

Clause 11: The method of any of clauses 1 through 10, wherein the one or more channel access parameters indicated via the one or more first messages includes a first set of channel access parameters for a first subset of wireless devices of the one or more second wireless devices that is associated with the first wireless device and a second set of channel access parameters for a second subset of wireless devices of the one or more second wireless devices that is unassociated with the first wireless device.

Clause 12: The method of any of clauses 1 through 11, further comprising: transmitting, to the one or more second wireless devices, an ID associated with the first wireless device, one or more capability messages indicating support for service period coordination, or a combination thereof, wherein the one or more first messages are transmitted in accordance with the one or more capability messages.

Clause 13: The method of any of clauses 1 through 12, wherein transmitting the one or more first messages comprises: transmitting, via one or more elements of each respective first message of the one or more first messages, an indication of one or more schedules of a set of schedules being associated with the one or more service periods.

Clause 14: The method of clause 13, wherein transmitting the indication of the one or more schedules comprises: transmitting, via each respective first message, a first bit within a control element indicating a presence of a bitmap, wherein the respective first message comprises the bitmap based at least in part on the first bit within the element

Clause 15: The method of clause 14, wherein the bitmap comprises a set of bits for the set of schedules and each respective bit of the set of bits indicates whether a respective schedule is associated the one or more service periods.

Clause 16: The method of any of clauses 13 through 15, wherein transmitting the indication of the one or more schedules comprises: transmitting, via each respective first message, one or more indications of the one or more schedules of the set of schedules that are associated with the one or more service periods via an information field within the one or more first messages, wherein each respective indication of the one or more indications is for a respective schedule of the one or more schedules.

Clause 17: The method of any of clauses 13 through 16, wherein the one or more schedules of the set of schedules that are associated with the one or more service periods are coordinated restricted target wake time schedules.

Clause 18: The method of any of clauses 1 through 17, wherein transmitting the one or more first messages comprises: transmitting, via an element of each respective first message of the one or more first messages, an indication of an operation type for a respective schedule indicated via the one or more first messages.

Clause 19: The method of clause 18, wherein transmitting the indication of the operation type comprises: transmitting, via each respective first message, a first bit within a control element indicating a presence of an operation type field, the operation type field comprising the indication of operation type.

Clause 20: The method of any of clauses 18 through 19, wherein transmitting the indication of the operation type comprises: transmitting, via each respective first message, the indication of the operation type within an information element.

Clause 21: The method of any of clauses 18 through 20, wherein operation type comprises an acceptance operation, a rejection operation, a modification operation, or any combination thereof.

Clause 22: The method of any of clauses 1 through 21, wherein transmitting the one or more first messages comprises: transmitting, via an element of each respective first message of the one or more first messages, an indication one or more sets of TWT parameters for one or more schedules associated with the one or more service periods.

Clause 23: The method of clause 22, wherein transmitting the indication of the one or more sets of TWT parameters comprises: transmitting, via each respective first message, a first bit within a control element indicating a presence of a field that indicates the one or more sets of TWT parameters.

Clause 24: The method of any of clauses 22 through 23, wherein transmitting the indication of the one or more sets of TWT parameters comprises: transmitting, via each respective first message, a first bit within a control element indicating a presence of a field that indicates a respective set of TWT parameters of the one or more sets of TWT parameters for a respective schedule of the one or more schedules.

Clause 25: A method for wireless communications, comprising: receiving, from a first wireless device at a second wireless device, one or more first messages indicating one or more service periods associated with the first wireless device and one or more channel access parameters for the second wireless device to apply during the one or more service periods associated with the first wireless device; and communicating, during the one or more service periods, in accordance with the one or more channel access parameters indicated via the one or more first messages.

Clause 26: The method of clause 25, wherein receiving the one or more first messages comprises: receiving, from the first wireless device, the one or more first messages indicating a request that the second wireless device refrains from transmitting communications during the one or more service periods, at a start of the one or more service periods, or a combination thereof; and transmitting, to the first wireless device, a second message indicating a response to a first message of the one or more first messages.

Clause 27: The method of clause 26, wherein the response to the first message indicates an acceptance to refrain from transmitting the communications during the one or more service periods in accordance with the one or more channel access parameters, a proposed modification of the request to refrain from transmitting the communications during the one or more service periods in accordance with the one or more channel access parameters, a rejection to refrain from transmitting the communications during the one or more service periods in accordance with the one or more channel access parameters, or any combination thereof.

Clause 28: The method of any of clauses 25 through 27, wherein receiving the one or more first messages comprises: receiving, from the first wireless device, an indication to refrain from transmitting communications during the one or more service periods.

Clause 29: The method of any of clauses 25 through 28, wherein receiving the one or more first messages comprises: receiving, from the first wireless device, a first group addressed message that indicates the one or more service periods associated with the first wireless device and the one or more channel access parameters for the second wireless device during the one or more service periods associated with the first wireless device; and transmitting, to one or more third wireless devices, a second group addressed message that indicates the one or more service periods associated with the first wireless device and one or more second channel access parameters for the one or more third wireless devices during the one or more service periods associated with the first wireless device, the one or more second channel access parameters being in accordance with the one or more channel access parameters for the second wireless device, wherein the second wireless device is an access point for a subset of the one or more third wireless devices.

Clause 30: The method of any of clauses 25 through 29, wherein each respective first message of the one or more first messages comprises a first bit that indicates a presence of the one or more channel access parameters to apply during the one or more service periods within the respective first message, a presence of an extension frame within the respective first message, a presence of additional information for the indicated one or more service periods associated with the first wireless device, or a combination thereof.

Clause 31: The method of any of clauses 25 through 30, further comprising: receiving, from the first wireless device, an indication of a public key associated with the first wireless device; transmitting, to the first wireless device, an indication of a public key associated with the second wireless device; and obtaining a common key in accordance with receiving the indication of the public key associated with the first wireless device and transmitting the indication of the public key associated with the second wireless device, wherein the one or more first messages received are associated at least in part with the common key.

Clause 32: The method of any of clauses 25 through 31, wherein the one or more first messages associates the one or more channel access parameters with an ID that is associated with the one or more service periods.

Clause 33: The method of clause 32, wherein a third wireless device that is associated with the one or more service periods, an ID of a coordination scheme associated with the one or more service periods, or a combination thereof.

Clause 34: The method of any of clauses 25 through 33, wherein the one or more channel access parameters indicated in the one or more first messages includes a set of channel access parameters for the second wireless device and for one or more third wireless devices that are associated with the second wireless device.

Clause 35: The method of any of clauses 25 through 34, further comprising: receiving, from the first wireless device, an ID associated with the first wireless device, one or more capability messages indicating support for service period coordination, or a combination thereof, wherein the one or more first messages are received in accordance with the one or more capability messages.

Clause 36: The method of any of clauses 25 through 35, wherein receiving the one or more first messages comprises: receiving, via one or more elements of each respective first message of the one or more first messages, an indication of one or more schedules of a set of schedules being associated with the one or more service periods.

Clause 37: The method of clause 36, wherein receiving the indication of the one or more schedules comprises: transmitting, via each respective first message, a first bit within a control element indicating a presence of a bitmap, wherein the respective first message comprises the bitmap based at least in part on the first bit within the element

Clause 38: The method of clause 37, wherein the bitmap comprises a set of bits for the set of schedules and each respective bit of the set of bits indicates whether a respective schedule is associated the one or more service periods.

Clause 39: The method of any of clauses 36 through 38, wherein receiving the indication of the one or more schedules comprises: receiving, via each respective first message, one or more indications of the one or more schedules of the set of schedules that are associated with the one or more service periods via an information field within the one or more first messages, wherein each respective indication of the one or more indications is for a respective schedule of the one or more schedules.

Clause 40: The method of any of clauses 36 through 39, wherein the one or more schedules of the set of schedules that are associated with the one or more service periods are coordinated restricted target wake time schedules.

Clause 41: The method of any of clauses 25 through 40, wherein receiving the one or more first messages comprises: receiving, via an element of each respective first message of the one or more first messages, an indication of an operation type for a respective schedule indicated via the one or more first messages.

Clause 42: The method of clause 41, wherein receiving the indication of the operation type comprises: receiving, via each respective first message, a first bit within a control element indicating a presence of an operation type field, the operation type field comprising the indication of operation type.

Clause 43: The method of any of clauses 41 through 42, wherein receiving the indication of the operation type comprises: transmitting, via each respective first message, the indication of the operation type within an information element.

Clause 44: The method of any of clauses 41 through 43, wherein operation type comprises an acceptance operation, a rejection operation, a modification operation, or any combination thereof.

Clause 45: The method of any of clauses 25 through 44, wherein receiving the one or more first messages comprises: receiving, via an element of each respective first message of the one or more first messages, an indication one or more sets of TWT parameters for one or more schedules associated with the one or more service periods.

Clause 46: The method of clause 45, wherein receiving the indication of the one or more sets of TWT parameters comprises: receiving, via each respective first message, a first bit within a control element indicating a presence of a field that indicates the one or more sets of TWT parameters.

Clause 47: The method of any of clauses 45 through 46, wherein receiving the indication of the one or more sets of TWT parameters comprises: receiving, via each respective first message, a first bit within a control element indicating a presence of a field that indicates a respective set of TWT parameters of the one or more sets of TWT parameters for a respective schedule of the one or more schedules.

Clause 48: A method for wireless communications, comprising: transmitting, from a first AP to a second AP, a first individually addressed management frame, the first individually addressed management frame comprising an indication of at least one requested coordination scheme between the first AP and the second AP, the at least one requested coordination scheme associated with one or more coordinated restricted target wake time schedules, and the first individually addressed management frame further comprising an element that indicates a respective requested parameter set associated with each coordinated restricted target wake time schedule of the one or more coordinated restricted target wake time schedules; receiving, from the second AP, a second individually addressed management frame comprising an indication of an acceptance of at least one coordinated restricted target wake time schedule of the one or more coordinated restricted target wake time schedules; and communicating one or more messages during one or more service periods of the at least one coordinated restricted target wake time schedule.

Clause 49: The method of clause 48, wherein transmitting the first individually addressed management frame comprises: transmitting, to the second AP, the first individually addressed management frame indicating a request that the second AP refrain from transmitting communications during the one or more coordinated restricted target wake time schedules, at a start of the one or more coordinated restricted target wake time schedules, or a combination thereof; and receiving, from the second AP, a response to the first individually addressed management frame, wherein the response is received prior to communicating the one or more messages.

Clause 50: The method of any of clauses 48 and 49, further comprising: transmitting, to the second AP, an indication of a first public key associated with the first AP; receiving, from the second AP, an indication of a second public key associated with the second AP; and obtaining a common key in accordance with transmitting the indication of the first public key associated with the first AP and receiving the indication of the second public key associated with the second AP, wherein the first individually addressed management frame is associated at least in part with the common key.

Clause 51: The method of any of clauses 48 through 50, further comprising: transmitting, to the second AP, an identifier associated with the first AP, one or more capabilities indicating support for service period coordination, or a combination thereof, wherein the first individually addressed management frame comprises the one or more capabilities.

Clause 52: The method of any of clauses 48 through 51, wherein the element comprises a coordination element, a target wake time element, or both.

Clause 53: The method of any of clauses 48 through 52, wherein the coordination scheme comprises a coordinated-restricted target wake time scheme, a coordinated-spatial reuse scheme, a coordinated-time division multiple access scheme, or any combination thereof.

Clause 54: An apparatus for wireless communication, comprising one or more memories storing processor-executable code, and one or more processors coupled with the one or more memories and individually or collectively operable to execute the code to cause the apparatus to perform a method of any of clauses 1 through 24 and 48 through 53.

Clause 55: An apparatus for wireless communication, comprising at least one means for performing a method of any of clauses 1 through 24 and 48 through 53.

Clause 56: A non-transitory computer-readable medium storing code for wireless communication, the code comprising instructions executable by one or more processors to perform a method of any of clauses 1 through 24 and 48 through 53.

Clause 57: An apparatus for wireless communications, comprising one or more memories storing processor-executable code, and one or more processors coupled with the one or more memories and individually or collectively operable to execute the code to cause the apparatus to perform a method of any of clauses 25 through 47.

Clause 58: An apparatus for wireless communications, comprising at least one means for performing a method of any of clauses 25 through 47.

Clause 59: A non-transitory computer-readable medium storing code for wireless communications, the code comprising instructions executable by one or more processors to perform a method of any of clauses 25 through 47.

In some implementations, one or more of the multiple memories may be configured to store processor-executable code that, when executed, may configure one or more of the multiple processors to perform various functions described herein (as part of a processing system). In some other implementations, the processing system may be pre-configured to perform various functions described herein.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions also may be physically located at various positions, including being distributed such that portions of functions are implemented at different physical locations. Also, as used herein, including in the claims, “or” as used in a list of items (such as a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrases “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communication, comprising:
a processing system that includes processor circuitry and memory circuitry that stores code, the processing system configured to cause the apparatus to:
transmit, from a first access point (AP) to a second AP, a first individually addressed management frame, the first individually addressed management frame comprising an indication of at least one requested coordination scheme between the first AP and the second AP, the at least one requested coordination scheme associated with one or more coordinated restricted target wake time schedules, and the first individually addressed management frame further comprising an element that indicates a respective requested parameter set associated with each coordinated restricted target wake time schedule of the one or more coordinated restricted target wake time schedules;
receive, from the second AP, a second individually addressed management frame comprising an indication of an acceptance of at least one coordinated restricted target wake time schedule of the one or more coordinated restricted target wake time schedules; and
communicate one or more messages during one or more service periods of the at least one coordinated restricted target wake time schedule.

2. The apparatus of claim 1, wherein, to transmit the first individually addressed management frame, the processing system is configured to cause the apparatus to:
transmit, to the second AP, the first individually addressed management frame indicating a request that the second AP refrains from transmitting communications during the one or more coordinated restricted target wake time schedules, at a start of the one or more coordinated restricted target wake time schedules, or a combination thereof; and
receive, from the second AP, a response to the first individually addressed management frame, wherein the response is received prior to communicating the one or more messages.

3. The apparatus of claim 1, wherein the processing system is further configured to cause the apparatus to:
transmit, to the second AP, an indication of a first public key associated with the first AP;
receive, from the second AP, an indication of a second public key associated with the second AP; and
obtain a common key in accordance with transmitting the indication of the first public key associated with the first AP and receiving the indication of the second public key associated with the second AP, wherein the first individually addressed management frame is associated at least in part with the common key.

4. The apparatus of claim 1, wherein the processing system is further configured to cause the apparatus to:
transmit, to the second AP, an identifier associated with the first AP, one or more capabilities indicating support for service period coordination, or a combination thereof, wherein the first individually addressed management frame comprises the one or more capabilities.

5. The apparatus of claim 1, wherein the element comprises a coordination element, a target wake time element, or both.

6. The apparatus of claim 1, wherein the at least one requested coordination scheme is of a plurality of coordination schemes, and wherein the plurality of coordination schemes comprises a coordinated-restricted target wake time scheme, a coordinated-spatial reuse scheme, a coordinated-time division multiple access scheme, or any combination thereof.

7. The apparatus of claim 1, wherein the second individually addressed management frame comprises at least one flag indicating the at least one coordinated restricted target wake time schedule of the one or more coordinated restricted target wake time schedules.

8. An apparatus for wireless communications, comprising:
a processing system that includes processor circuitry and memory circuitry that stores code, the processing system configured to cause the apparatus to:
receive, from a first access point (AP) at a second AP, a first individually addressed management frame, the first individually addressed management frame comprising an indication of at least one requested coordination scheme between the first AP and the second AP, the at least one requested coordination scheme associated with one or more coordinated restricted target wake time schedules, and the first individually addressed management frame further comprising an element that indicates a respective requested parameter set associated with each coordinated restricted target wake time schedule of the one or more coordinated restricted target wake time schedules; and
transmit, to the first AP, a second individually addressed management frame comprising an indication of an acceptance of at least one coordinated restricted target wake time schedule of the one or more coordinated restricted target wake time schedules.

9. The apparatus of claim 8, wherein, to receive the first individually addressed management frame, the processing system is configured to cause the apparatus to:
receive, from the first AP, the first individually addressed management frame indicating a request that the second AP refrains from transmitting communications during the one or more coordinated restricted target wake time schedules, at a start of the one or more coordinated restricted target wake time schedules, or a combination thereof.

10. The apparatus of claim 8, wherein the processing system is further configured to cause the apparatus to:
receive, from the first AP, an indication of a first public key associated with the first AP; and
transmit, to the first AP, an indication of a second public key associated with the second AP, wherein the first individually addressed management frame is associated at least in part with a common key that is based at least in part on the first public key and the second public key.

11. The apparatus of claim 8, wherein the processing system is further configured to cause the apparatus to:
receive, from the first AP, an identifier associated with the first AP, one or more capabilities indicating support for service period coordination, or a combination thereof, wherein the first individually addressed management frame comprises the one or more capabilities.

12. The apparatus of claim 8, wherein the element comprises a coordination element, a target wake time element, or both.

13. The apparatus of claim 8, wherein the at least one requested coordination scheme is of a plurality of coordination schemes, and wherein the plurality of coordination schemes comprises a coordinated-restricted target wake time scheme, a coordinated-spatial reuse scheme, a coordinated-time division multiple access scheme, or any combination thereof.

14. The apparatus of claim 8, wherein the second individually addressed management frame comprises at least one flag indicating the at least one coordinated restricted target wake time schedule of the one or more coordinated restricted target wake time schedules.

15. A method for wireless communications, comprising:
transmitting, from a first access point (AP) to a second AP, a first individually addressed management frame, the first individually addressed management frame comprising an indication of at least one requested coordination scheme between the first AP and the second AP, the at least one requested coordination scheme associated with one or more coordinated restricted target wake time schedules, and the first individually addressed management frame further comprising an element that indicates a respective requested parameter set associated with each coordinated restricted target wake time schedule of the one or more coordinated restricted target wake time schedules;
receiving, from the second AP, a second individually addressed management frame comprising an indication of an acceptance of at least one coordinated restricted target wake time schedule of the one or more coordinated restricted target wake time schedules; and
communicating one or more messages during one or more service periods of the at least one coordinated restricted target wake time schedule.

16. The method of claim 15, wherein transmitting the first individually addressed management frame comprises:
transmitting, to the second AP, the first individually addressed management frame indicating a request that the second AP refrains from transmitting communications during the one or more coordinated restricted target wake time schedules, at a start of the one or more coordinated restricted target wake time schedules, or a combination thereof; and
receiving, from the second AP, a response to the first individually addressed management frame, wherein the response is received prior to communicating the one or more messages.

17. The method of claim 15, further comprising:
transmitting, to the second AP, an indication of a first public key associated with the first AP;
receiving, from the second AP, an indication of a second public key associated with the second AP; and
obtaining a common key in accordance with transmitting the indication of the first public key associated with the first AP and receiving the indication of the second public key associated with the second AP, wherein the first individually addressed management frame is associated at least in part with the common key.

18. The method of claim 15, further comprising:
transmitting, to the second AP, an identifier associated with the first AP, one or more capabilities indicating support for service period coordination, or a combination thereof, wherein the first individually addressed management frame comprises the one or more capabilities.

19. The method of claim 15, wherein the element comprises a coordination element, a target wake time element, or both.

20. The method of claim 15, wherein the at least one requested coordination scheme is of a plurality of coordination schemes, and wherein the plurality of coordination schemes comprises a coordinated-restricted target wake time scheme, a coordinated-spatial reuse scheme, a coordinated-time division multiple access scheme, or any combination thereof.
